(19) United States
(12) Patent Application Publication
(10) Pub. No.: US 2004/0122882 A1
(43) Pub. Date: Jun. 24, 2004

(54) Equation solving

(76) Inventors: Yuriy Zakharov, York (GB); Timothy Conrad Tozer, Elvington (GB)

Correspondence Address: GATES & COOPER LLP, HOWARD HUGHES CENTER, 6701 CENTER DRIVE WEST, SUITE 1050, LOS ANGELES, CA, 90045, US

(21) Appl. No.: 10/685,983

(22) Filed: Oct. 15, 2003

(30) Foreign Application Priority Data
Apr. 11, 2002 (GB) 0208329.3

(51) Int. Cl. G06F 7/38

(52) U.S. Cl. 708/446

(57) ABSTRACT

A method for solving a system of N linear equations in N unknown variables. The method comprising:

(a) storing an estimate value for each unknown variable;

(b) initialising each estimate value to a predetermined value;

(c) for each estimate value:

(i) determining whether a respective predetermined condition is satisfied; and

(ii) updating the estimate if and only if the respective predetermined condition is satisfied; and

repeating step (c) until each estimate value is sufficiently close to an accurate value of the respective unknown variable.

### CROSS REFERENCE TO RELATED APPLICATIONS

This application is a continuation in part of International Application PCT/GB03/001568, filed Apr. 10, 2003, which claims priority to Great Britain Application No. GB 0208329.3, filed Apr. 11, 2002, the contents of each of which are incorporated herein by reference.

### FIELD OF INVENTION

The present invention relates to systems and methods for solving systems of linear equations.

### BACKGROUND OF INVENTION

Systems of linear equations occur frequently in many branches of science and engineering. Effective methods are needed for solving such equations. It is desirable that systems of linear equations are solved as quickly as possible.

A system of linear equations typically comprises N equations in N unknown variables. For example, where N=3 an example system of equations is set out below:

15x+5y−2z=15

5x+11y+4z=47

−2x+4y+9z=51

In this case, it is necessary to find values of x, y, and z which satisfy all three equations. Many methods exist for finding such values of x, y and z and in this case it can be seen that x=1, y=2 and z=5 is the unique solution to the system of equations.

In general terms, existing methods for solving linear equations can be categorised as either direct methods, or iterative methods. Direct methods attempt to produce an exact solution by using a finite number of operations. Direct methods however suffer from a problem in that the number of operations required is often large which makes the method slow. Furthermore, some implementations of such methods are sensitive to truncation errors.

Iterative methods solve a system of linear equations by repeated refinements of an initial approximation until a result is obtained which is acceptably close to the accurate solution. Each iteration is based on the result of the previous iteration, and, at least in theory, each iteration should improve the previous approximation. Generally, iterative methods produce an approximate solution of the desired accuracy by yielding a sequence of solutions which converge to the exact solution as the number of iterations tends to infinity.

It will be appreciated, that systems of linear equations are often solved using a computer apparatus. Often, equations will be solved by executing appropriate program code on a microprocessor. In general terms, a microprocessor can represent decimal numbers in fixed point or floating point form.

In fixed point form, a binary number of P bits comprises a first part of length q and a second part of length r. The first part represents the whole number part, and the second part represents the fractional part. In general terms, arithmetic operations can be relatively efficiently implemented for fixed point numbers. However, fixed point numbers suffer from problems of flexibility given that the position of the decimal point is fixed and therefore the range of numbers which can be accurately represented is relatively small given that overflow and round off errors regularly occur.

Floating point numbers again in general terms comprise two parts. A first part, known as the exponent, and a second part known as the mantissa. The mantissa represents the binary number, and the exponent is used to determine the position of the decimal point within that number.

For example considering an eight bit value 00101011 where the first bit represents sign, the subsequent three bits represent the exponent, and the final four bits represent the mantissa, this value is analysed as follows. The first bit represents sign, and is interpreted such that the number is positive if the sign bit is equal to ‘0’ and negative if the sign bit is equal to ‘1’. In this case, given that the first bit is ‘0’, the number is determined to be positive. The mantissa (1011) is written out and a decimal point is placed to its left side as follows:

0.1011

The exponent is then interpreted as an integer, that is 010 is interpreted as the integer value 2 (given that the first bit of the exponent field is a sign bit which determines the direction in which the decimal point should move). In this case, the decimal point is moved to the right two bits to give:

10.11

Which represents a value of two and three quarters.

Although floating point numbers give considerable benefits in terms of their flexibility, arithmetic operations involving floating point numbers are inherently slower than corresponding operations on fixed point numbers. Therefore, where possible, the benefits of speed associated with fixed point numbers should be exploited.

When considering the implementation of an algorithm in hardware, its efficiency is a prime concern. Many algorithms for the solution of linear equations involve computationally expensive division and/or multiplication operations. These operations should, where possible be avoided, although this is often not possible with known methods for solving linear equations.

Many systems of linear equations have sparse solutions. In such cases the number of iterations required to solve the system of equations should be relatively low. However, this does not occur with some known methods.

In summary there is a need for a more efficient algorithm which can be used to solve systems of linear equations.

It is an object of the present invention to obviate or mitigate at least one of the problems identified above.

### SUMMARY OF THE INVENTION

According to a first aspect of the present invention, there is provided a method for solving a system of N linear equations in N unknown variables, the method comprising:

(a) storing an estimate value for each unknown variable;

(b) initialising each estimate value to a predetermined value;

(c) for each estimate value:

(i) determining whether a respective predetermined condition is satisfied; and

(ii) updating the estimate if and only if the respective predetermined condition is satisfied; and

(d) repeating step (c) until each estimate value is sufficiently close to an accurate value of the respective unknown variable.

Thus, the invention provides a method for solving linear equations in which estimates for solutions of the equations are updated only if a predetermined condition is satisfied. The predetermined condition is preferably related to convergence of the method. Therefore such an approach offers considerable benefits in terms of efficiency, given that updates are only carried out when such updates are likely to accelerate convergence.

According to a second aspect of the present invention, there is provided a method for solving a system of N linear equations in N unknown variables, the method comprising:

(a) storing an estimate value for each unknown variable;

(b) initialising each estimate value to a predetermined value;

(c) attempting to update each estimate value using a scalar value d;

(d) updating the scalar value if no updates are made in step (c); and

(e) repeating step (c) and step (d) until each estimate value is sufficiently close to an accurate value of the respective unknown variable.

By updating the scalar value in accordance with the second aspect of the present invention, it has been discovered that benefits of efficiency are obtained.

According to a third aspect of the present invention, there is provided a method for solving a system of N linear equations in N unknown variables of the form:

Rh=β

the method comprising:

generating a quadratic function of the form:

$$J ( h ) = {\sum }_{m = 1}^{N} {\sum }_{n = 1}^{N} R ( m , n ) h ( m ) h ( n ) - 2 {\sum }_{n = 1}^{N} β ( n ) h ( n ) ;$$

and

minimising said function using co-ordinate descent optimisation; wherein R is a coefficient matrix of the system of linear equations; h is a vector of the N unknown variables; β is a vector containing the value of the right hand side of each equation; R(m,n) is an element of the matrix R; h(m) is the mth element of the matrix h; and β (n) is the nth element of the vector β.

The present inventors have discovered that solving a system of linear equations by minimising a quadratic function using co-ordinate descent optimisation offers considerable and surprising efficiency benefits.

According to a fourth aspect of the present invention, there is provided a computer processor configured to solve a system of N linear equations in N unknown variables, comprising:

storage means for storing an estimate value for each unknown variable;

storage means for storing coefficients of each unknown variable in each equation;

storage means for storing a scalar value d;

initialising means for initialising each estimate value;

computing means configured to process each estimate value by determining whether a respective predetermined condition is satisfied, and to update the estimate if and only if the respective predetermined condition is satisfied, said computing means being configured to repeatedly process each estimate value until each estimate value is sufficiently close to an accurate value of the respective unknown variable.

According to a fifth aspect of the present invention, there is provided a computer processor configured to solve a system of N linear equations in N unknown variables, comprising:

storage means for storing an estimate value for each unknown variable;

storage means for storing coefficients of each unknown variable in each equation;

storage means for storing a scalar value d;

initialising means for initialising each estimate value;

computing means configured to:

(a) attempt to update each estimate value using a scalar value d,

(b) update the scalar value d if no updates are made in step (a); and

(c) repeat step (a) and step (b) until each estimate value is sufficiently close to an accurate value of the respective unknown variable.

According to a sixth aspect of the present invention, there is provided a multiuser receiver device for obtaining data transmitted by a plurality users, the device comprising:

a plurality of filters, each filter being arranged to filter out a spreading code used by a respective user;

equation solving means to find a solution h of a system of linear equations of the form Rh=β where R is the cross correlation of the spreading codes used by the plurality of users, and β is a vector containing the filter output signals; and

means for obtaining the transmitted data using a solution provided by the equation solving means;

wherein the equation solving means:

(a) stores an estimate value for each value of the solution h;

(b) initialises each estimate value to a predetermined value;

(c) for each estimate value:

(i) determines whether a respective predetermined condition is satisfied; and

(ii) updates the estimate if and only if the respective predetermined condition is satisfied; and

(d) repeats step (c) until each estimate value is sufficiently close to an accurate value of the respective unknown variable.

According to a seventh aspect of the present invention, there is provided a multiuser receiver device for obtaining data transmitted by a plurality of users, the device comprising:

a plurality of filters, each filter being arranged to filter out a spreading code used by a respective user;

equation solving means to find a solution h of a system of linear equations of the form Rh=β where R is the cross correlation of the spreading codes used by the plurality of users, and β is a vector containing the filter output signals; and

means to obtain the transmitted data using a solution provided by the equation solving means;

wherein the equation solving means:

(a) stores an estimate value for each unknown variable;

(b) initialises each estimate value to a predetermined value;

(c) attempts to update each estimate value using a scalar value d;

(d) updates the scalar value if no updates are made in step (c); and

(e) repeats step (c) and step (d) until each estimate value is sufficiently close to an accurate value of the respective unknown variable.

According to an eighth aspect of the present invention, there is provided a method for generating filter coefficients for use in an echo cancellation apparatus, the method comprising:

(a) generating a cross correlation matrix R containing the cross correlation of first and second signals and;

(b) generating an auto correlation vector β containing an autocorrelation of the first signal; and

(c) determining a vector h for which Rh=β, said vector h containing the said filter coefficients;

wherein the vector h is determined by solving the system of equations Rh=β by:

(d) storing an estimate value for each element of the vector h;

(e) initialising each estimate value to a predetermined value;

(f) for each estimate value:

(i) determining whether a respective predetermined condition is satisfied; and

(ii) updating the estimate if and only if the respective predetermined condition is satisfied; and

(g) repeating step (f) until each estimate value is sufficiently close to an accurate value of the respective unknown variable.

According to a ninth aspect of the present invention, there is provided a method for generating filter coefficients for use in an echo cancellation apparatus, the method comprising:

(a) generating a cross correlation matrix R containing the cross correlation of first and second signals;

(b) generating an auto correlation vector β containing an autocorrelation of the first signal; and

(c) determining a vector h for which Rh=β, said vector h containing the said filter coefficients;

wherein the vector h is determined by solving the system of equations Rh=β by:

(d) storing an estimate value for each unknown variable;

(e) initialising each estimate value to a predetermined value;

(f) attempting to update each estimate value using a scalar value d;

(g) updating the scalar value if no updates are made in step (f); and

(h) repeating step (g) and step (h) until each estimate value is sufficiently close to an accurate value of the respective unknown variable.

### BRIEF DESCRIPTION OF DRAWINGS

Embodiments of the present invention will now be described, by way of example, with reference to the accompanying drawings, in which:

FIG. 1 is a flow chart of an algorithm for solving linear equations in accordance with the present invention;

FIG. 2 is a graph showing how the value of the solution vector changes as the algorithm of FIG. 1 solves a system of equations;

FIG. 3 is a graph showing how the error of the solution vector varies as the algorithm of FIG. 1 solves the system of equations;

FIG. 4 is a graph showing how the number of passes through the system equations varies in dependence upon the bit number of the solution vector elements being considered in the algorithm of FIG. 1;

FIG. 5 is a graph showing the number of updates to the solution vector carried out for each bit as the algorithm of FIG. 1 solves the system of equations;

FIG. 6 is a flow chart showing a variant to the algorithm of FIG. 1;

FIG. 7 is a MATLAB code fragment implementing the algorithm of FIG. 6;

FIG. 8 is a flow chart showing a variant to the algorithm of FIG. 6, where values of the solution vector are constrained between upper and lower bounds.

FIG. 9 is flow chart showing how the algorithm of FIG. 1 can be adapted to solve equations having complex coefficients and complex solutions;

FIG. 10 is a flow chart showing a method for determining the next course of action in a step of FIG. 9;

FIG. 11 is a flow chart showing a variant to the algorithm of FIG. 10;

FIG. 12 is a MATLAB code fragment implementing the algorithm of FIG. 11;

FIG. 13 is a schematic illustration of a device configured to solve linear equations in accordance with the invention;

FIG. 14 is a schematic illustration of the equation solving microprocessor of FIG. 13;

FIG. 15 is a schematic illustration showing block R of FIG. 14 in further detail;

FIG. 16 is a schematic illustration showing block h of FIG. 14 in further detail;

FIG. 17 is a schematic illustration showing how the block h of FIG. 16 is modified when equations having complex valued solutions are to be solved;

FIG. 18 is a schematic illustration showing block Q of FIG. 14 in further detail;

FIG. 19 is a schematic illustration showing the minimisation block of FIG. 14 in further detail;

FIG. 19a is a MATLAB code fragment showing a variant to the algorithm of FIG. 7;

FIG. 20 is a schematic illustration of a CDMA receiver device in which algorithms of the present invention may be applied;

FIG. 21 is a schematic illustration of an echo cancellation apparatus in which the algorithms of the present invention may be applied; and

FIG. 22 is a schematic illustration showing part of the apparatus of FIG. 21 in further detail.

### DESCRIPTION OF PREFERRED EMBODIMENTS

A method for a system of solving linear equations is now described. A system of linear equations can be expressed in the form:

Rh=β (1)

where: R is a coefficient matrix of the system of equations;

h is a vector of the unknown variables; and

β is a vector containing the value of the right hand side of each equations

For example, the system of equations (2):

15x+5y−2z=15

5x+11y+4z=47

−2x+4y+9z=51 (2)

can be expressed in the form of equation (1) where:

$$R = [ \begin{matrix}15 & 5 & - 2 \\ 5 & 11 & 4 \\ - 2 & 4 & 9\end{matrix} ] h = [ \begin{matrix}x \\ y \\ z\end{matrix} ] β = [ \begin{matrix}15 \\ 47 \\ 51\end{matrix} ] \qquad ( 3 )$$

To solve the system of equations, it is necessary to find values for x, y, and z of h which satisfy each of the three equations.

In operation, algorithm uses the matrix R and the vectors h and β as set out above, together with an auxiliary vector Q. The vector h is initialised to a predetermined initial value (see below) and updated as the algorithm proceeds until its elements represent the solution of the equations.

For a system of N equations in N unknown variables, the vector h has length N and the matrix R is of size N×N.

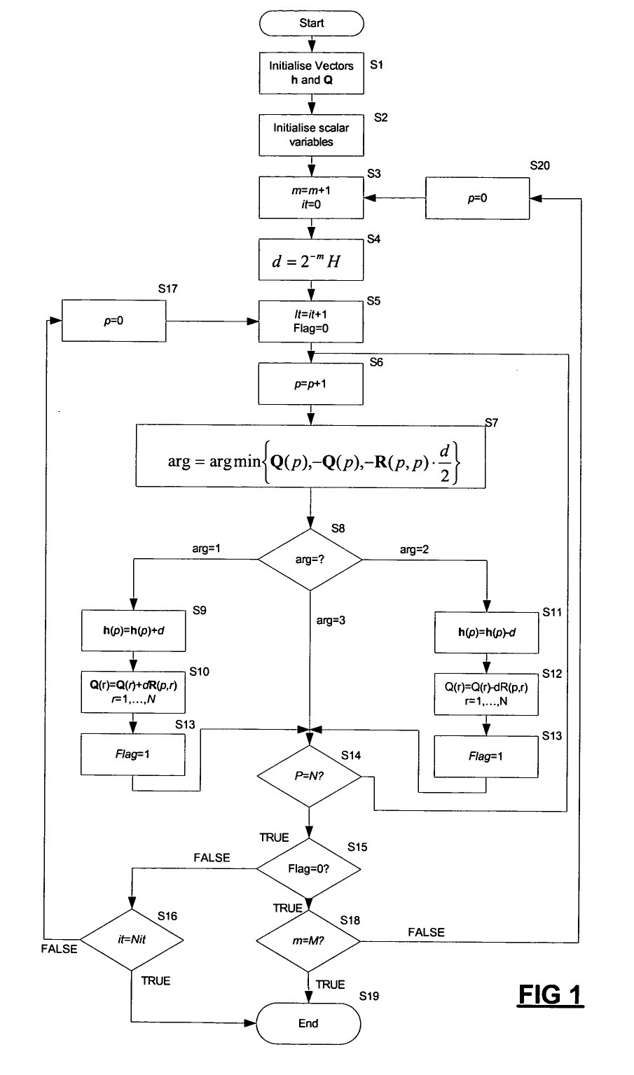

Referring to FIG. 1, at step S1 the vectors h and Q are initialised. The vector h is initialised such that all its elements are set to ‘0’. The vector Q is initialised to contain the negative of the equivalent position of β. That is:

Q=−β (4)

Therefore, when working with system of equations (2), Q is initialised in accordance with equation (5):

$$Q = [ \begin{matrix}- 15 \\ - 47 \\ - 51\end{matrix} ] \qquad ( 5 )$$

The algorithm maintains three counter variables p, m and it, a parameter N which represents the number of elements in the solution vector (and also the number of equations), a parameter M which represents the number of bits used to represent each element of the solution vector h, a parameter Nit which represents the maximum number of iterations through which the algorithm can pass for a particular value of m, a variable Flag which is used to indicate whether or not the solution vector has been updated, and a constant H, the purpose of which is described below.

Some of these variables are initialised at step S2 and step S3 of FIG. 1. p, m and it are all initialised to zero. N, M, and Nit are set to the values described above which can either be chosen by a user or hard coded into the algorithm. Selection and initialisation of H is described below.

Operation of the algorithm can be summarised as follows. Each bit m of all elements p of the solution vector h is considered in turn. As described below, for each bit an element of the vector Q is compared with various conditions and the result of this comparison determines whether or not further processing is applicable. This further processing comprises an appropriate update of the element p of the solution vector h corresponding to the element being considered and updates of all elements of the auxiliary vector Q.

When it is determined that further processing for that element is not appropriate (for the current bit), the next element is considered. When each element has been considered for that particular bit, all elements of the solution vector are considered for the next bit in turn, and updated appropriately. This process continues until all elements have been considered for all bits. If the total number of iterations for any one bit reaches a predetermined limited the algorithm again ends. The algorithm is described in further detail below.

At step S3, the value of m is incremented to ‘1’. Thus, the algorithm is now considering the first bit of each element in the solution vector h. it is set to 0 to indicate that no iterations have yet taken place for the current value of m.

At Step S4, a step size parameter d is calculated according to the equation:

d=2^{-m}H (6)

where m and H are the parameters described above.

H is a value greater than or equal to the magnitude of the maximum value which is expected for any value of the solution vector. That is, the algorithm considers only solutions lying between −H and +H.

As will be described below, setting d in accordance with equation (6) allows each bit of each value of the solution vector h to be considered in turn.

At Step S5 of FIG. 1, the variable it is incremented, and the variable Flag is set to ‘0’. p (the current element of the solution vector under consideration) is incremented at Step S6.

Having performed the necessary incrementation and initialisation, the algorithm can begin processing elements of the matrix and vectors, in an attempt to solve the equations.

At step S7, the following operation is performed:

$$\begin{matrix}arg = arg min \{ Q ( p ) , - Q ( p ) , - R ( p , p ) \cdot \frac{d}{2} \} \\ where & ( 7 ) \\ arg min = \{ \begin{matrix}1 , if \{ Q ( p ) < - Q ( p ) ⋀ Q ( p ) < - R ( p , p ) \cdot \frac{d}{2} \} \\ 2 , if \{ - Q ( p ) < Q ( p ) ⋀ - Q ( p ) < - R ( p , p ) \cdot \frac{d}{2} \} \\ 3 , if \{ - R ( p , p ) \cdot \frac{d}{2} \leq Q ( p ) ⋀ - R ( p , p ) \cdot \frac{d}{2} \leq - Q ( p ) \}\end{matrix} & ( 8 )\end{matrix}$$

The value of arg is assessed at the decision block of step S8.

If arg=1, the element of the solution vector under consideration, that is h(p) is set according to equation (9) at step S9.

h(p)=h(p)+d (9)

The auxiliary vector Q is then updated such that all values of Q are set according to equation (10) at step S11.

Q(r)=Q(r)+dR(p,r),∀r:1≦r≦N (10)

If arg=2, the element of the solution vector under consideration, that is h(p), is set according to equation (11) at step S11.

h(p)=h(p)−d (11)

The auxiliary vector Q is then updated such that all values of Q are set according to equation (12) at step S10.

Q(r)=Q(r)−dR(p,r),∀r:1≦r≦N (12)

If arg=1 or if arg=2, Flag is set to ‘1’ at step S13.

If arg=3, no update is made to any element of the solution vector h or the auxiliary vector Q, and Flag is not updated.

Having made the updates set out above, a decision block at step S14 checks the condition of equation (13);

p=N (13)

If p is not equal to N (i.e. all elements of the solution vector h have not yet been considered), control returns to step S6 and p is incremented. This process continues until all entries in the solution vector h have been considered, and h and Q are updated in the manner set out above.

If p is equal to N (step S14), a check is made to determine the value of Flag (step S15).

Flag is initially set to ‘0’ at step S5, and only updated (to be equal to ‘1’) if entries of the solution and auxiliary vectors are amended by steps S9 and S10, or steps S11 and S12. Thus, if Flag=1, it can be deduced that a change was made to at least one element of h (i.e. one h(p) value) and all values of Q, for the current iteration it. Therefore, assuming that the total number of iterations it has not exceeded the limit set by Nit (checked at S16), p is reset to ‘0’ at step S17, control returns to step S5, and the current bit is again processed for each element p of the solution vector h. This is because further processing of each element of h for the current value of m may result in further updates. If the total number of iterations has reached the limit set by Nit (step S16), the algorithm exits.

If it is the case that Flag=0 (step 15), it can be deduced that no updates have been made to any elements of the solution vector h or the auxiliary vector Q for any value of p (that is any element of the solution vector h). Given that further iterations of steps S5 to S15 will result in no changes to the elements of h (given that neither d, h nor Q have changed), a check is made to determine whether or not all bits m have been considered (step S18), by comparing the current value of m with the total number of bits M. If it is the case that m=M, i.e. all bits have been considered, there is no work for the algorithm to do, and the algorithm exits at step S19.

If it is the case that all bits have not been considered, p is reset to 0 at step S20, and control returns to step S3, and the algorithm processes the next bit of the solution vector entries.

In the preceding discussion, it has been explained that entries of the solution vector h are processed for each bit of the solution vector entries, starting with the most significant bit. However, it can be seen from the preceding discussion, that at all steps the entire value of an element of h is used for update. However bit wise processing is in fact achieved because following each increment of m (step S3) a new value of d is created at step S4. Given that each increment of m will result in the value of d being divided by two (given the presence of the expression 2^{-m} in the expression for d), and given that d is used to update both h and Q, after an update of d the next most significant bit is then updated.

It has been described that the value of H represents a value greater than or equal to the magnitude of the maximum value of the solution vector elements. In setting H it is desirable to ensure that it is a power of two. That is, H is set according to equation (14).

H=2^{q} (14)

where q is any integer (i.e. positive, negative or zero)

When H is set in this way, the expression for d set out in equation (6) becomes:

d=2^{-m}2^{q}

d=2^{q-m} (15)

Thus, when H is chosen in accordance with equation (14), the value of d can be updated without multiplication or division, simply by appropriate bit shift operations. This is particularly advantageous, because microprocessors can typically carry out bit shift operations far more efficiently than multiplication or division.

The application of the algorithm described with reference to FIG. 1 to the system of linear equations (2) set out above will now be described.

R and β are initialised as described above:

$$\begin{matrix}R = [ \begin{matrix}15 & 5 & - 2 \\ 5 & 11 & 4 \\ - 2 & 4 & 9\end{matrix} ] & ( 16 ) \\ β = [ \begin{matrix}15 \\ 47 \\ 51\end{matrix} ] & ( 17 )\end{matrix}$$

h and Q are initialised in the manner described above:

$$\begin{matrix}h = [ \begin{matrix}0 \\ 0 \\ 0\end{matrix} ] & ( 18 ) \\ Q = [ \begin{matrix}- 15 \\ - 47 \\ - 51\end{matrix} ] & ( 19 )\end{matrix}$$

Variables are initialised as follows at step S2 and step S3:

m=0 M=8

it=0 N=3

p=0 Nit=0 (20)

H is in this case set to 16, i.e. q=4 in equation (14).

m is incremented such that m=1, and it is set to ‘0’ (step S3). A value of d is computed according to equation (15) and in this case:

d=2⁴⁻¹

d=8 (21)

it is incremented to ‘1’ and Flag is set to ‘0’ at step S5. p is incremented to 1 at step S6. At step S7, the following expression is evaluated

$$arg = arg min \{ Q ( 1 ) , - Q ( 1 ) , - R ( 1 , 1 ) \cdot \frac{8}{2} \} \\ arg = arg min \{ - 15 , 15 , - 15 \cdot \frac{8}{2} \} \\ arg = arg min \{ - 15 , 15 , - 60 \} \qquad ( 22 )$$

Therefore, it can be seen from equations (8) and (22) that arg=3. The decision block at step S8 therefore passes control to step S14, where the condition p=N is checked. In this case p=1 and N=3, therefore p is not equal to N, and therefore control passes to step S6, with no changes having been made to the elements of h or Q.

Step S6 then increments p to be equal to 2 (i.e. the second element of the solution vector is being considered)

Step S7 computes:

$$arg = arg min \{ Q ( 2 ) , - Q ( 2 ) , - R ( 2 , 2 ) \cdot \frac{8}{2} \} \\ arg = arg min \{ - 47 , 47 , - 11 \cdot \frac{8}{2} \} \\ arg = arg min \{ - 47 , 47 , - 44 \} \qquad ( 23 )$$

Therefore, arg=1.

At step S8 the appropriate decision outcome is chosen, and at step S9, h is set as follows:

$$h \text{:} [ \begin{matrix}0 \\ 0 \\ 0\end{matrix} ] {\to }^{becomes} [ \begin{matrix}0 \\ 0 + d \\ 0\end{matrix} ] = [ \begin{matrix}0 \\ 8 \\ 0\end{matrix} ] \qquad ( 24 )$$

At step S10, all values of Q are set by adding the current values to the values of the second row (since p=2) of R multiplied by d:

$$\begin{matrix}Q \text{:} [ \begin{matrix}- 15 \\ - 47 \\ - 51\end{matrix} ] {\to }^{becomes} [ \begin{matrix}- 15 + d \cdot R ( 2 , 1 ) \\ - 47 + d \cdot R ( 2 , 2 ) \\ - 51 + d \cdot R ( 2 , 3 )\end{matrix} ] = [ \begin{matrix}- 15 + 8 \cdot 5 \\ - 47 + 8 \cdot 11 \\ - 51 + 8 \cdot 4\end{matrix} ] \\ = [ \begin{matrix}25 \\ 41 \\ - 19\end{matrix} ]\end{matrix} \qquad ( 25 )$$

At step S113, Flag is set to ‘1’ to show that h and Q have been updated.

At step S14 p is still not equal to N (p=2, N=3) and therefore control returns to step S6, where p is incremented to 3.

At step S7 the following is computed:

$$arg = arg min \{ Q ( 3 ) , - Q ( 3 ) , - R ( 3 , 3 ) \cdot \frac{8}{2} \} \\ arg = arg min \{ - 19 , 19 , - 9 \cdot \frac{8}{2} \} \\ arg = arg min \{ - 19 , 19 , - 36 \} \qquad ( 26 )$$

Therefore arg=3. No updates are made, and the condition of step S14 is checked. In this instance p=N=3, and the condition is therefore true. The value of Flag is then checked at step S15. Flag was set to ‘1’ at step S13 while p was set to 2, and therefore the condition of step S15 evaluates to false.

The condition of step S16 is then checked. Given that it=1, and Nit=10, the condition of step S16 returns False, and control passes to step S17 where p is reset to ‘0’ and then to step S5, where it is incremented and Flag is reset to ‘0’.

p is incremented at step S6, and at step S7, the following expression is considered

$$arg = arg min \{ Q ( 1 ) , - Q ( 1 ) , - R ( 1 , 1 ) \cdot \frac{8}{2} \} \\ arg = arg min \{ 25 , - 25 , - 15 \cdot \frac{8}{2} \} \\ arg = arg min \{ 25 , - 25 , - 60 \} \qquad ( 27 )$$

It can be seen from equation (27) that arg=3. The decision block therefore passes control to step S14, where the condition p=N is checked. In this case p=1 and N=3, therefore p is not equal to N, and control therefore passes to step S6, with no changes having been made to the elements of h or Q.

p is incremented to 2 at step S6 and the following expression is considered at step S7:

$$arg = arg min \{ Q ( 2 ) , - Q ( 2 ) , - R ( 2 , 2 ) \cdot \frac{8}{2} \} \\ arg = arg min \{ 41 , - 41 , - 11 \cdot \frac{8}{2} \} \\ arg = arg min \{ 41 , - 41 , - 44 \} \qquad ( 28 )$$

It can be seen from equation (28) that arg=3. The decision block therefore passes control to step S14, where the condition p=N is again checked. p is still not equal to N, and therefore control passes to step S6, with no changes having been made to the elements of h or Q.

The following expression is then considered:

$$arg = arg min \{ Q ( 3 ) , - Q ( 3 ) , - R ( 3 , 3 ) \cdot \frac{8}{2} \} \\ arg = arg min \{ - 19 , 19 , - 9 \cdot \frac{8}{2} \} \\ arg = arg min \{ - 19 , 19 , - 36 \} \qquad ( 29 )$$

Again, arg=3, and no updates are made. In this case the condition of step S14 returns true, and the condition of step S15 also returns true, given that no updates where made during the last pass through all elements of h, and consequently Flag is still set to ‘0’.

The condition of step S18 is then checked to determine whether all bits of the solution vector entries have been considered. In this case m=1 and M=8, therefore step S18 returns false. p is set to ‘0’ at step S20, and control passes to step S3 where m is incremented to 2 and it is reset to ‘0’.

At step S4 d is set where m is equal to 2, and therefore d=4. Note that as discussed above, d has been halved. At step S5 it is incremented to 1 and Flag is set to ‘0’.

p is incremented to 1 at step S6. At step S7, the following expression is considered:

$$arg = arg min \{ Q ( 1 ) , - Q ( 1 ) , - R ( 1 , 1 ) \cdot \frac{4}{2} \} \\ arg = arg min \{ 25 , - 25 , - 15 \cdot \frac{4}{2} \} \\ arg = arg min \{ 25 , - 25 , - 30 \} \qquad ( 30 )$$

Therefore arg=3, and no update takes place. The algorithm continues as described above, and p is incremented to 2 at step S6. At step S7 the following expression is evaluated:

$$arg = arg min \{ Q ( 2 ) , - Q ( 2 ) , - R ( 2 , 2 ) \cdot \frac{4}{2} \} \\ arg = arg min \{ 41 , - 41 , - 11 \cdot \frac{4}{2} \} \\ arg = arg min \{ 41 , - 41 , - 22 \} \qquad ( 31 )$$

In this case arg=2. The decision block of step S8 therefore directs control to step S11. Step S11 updates h by subtracting the current value of d (d=4) from the second element of h, as shown in equation (32):

$$h \text{:} [ \begin{matrix}0 \\ 8 \\ 0\end{matrix} ] {\to }^{becomes} [ \begin{matrix}0 \\ 8 - d \\ 0\end{matrix} ] = [ \begin{matrix}0 \\ 4 \\ 0\end{matrix} ] \qquad ( 32 )$$

Step S12 updates Q by subtracting the row of R (given that p=2) multiplied by d from the current values of Q as set out in equation (33):

$$\begin{matrix}Q \text{:} [ \begin{matrix}25 \\ 41 \\ - 19\end{matrix} ] {\to }^{becomes} [ \begin{matrix}25 - d \cdot R ( 2 , 1 ) \\ 41 - d \cdot R ( 2 , 2 ) \\ - 19 - d \cdot R ( 2 , 3 )\end{matrix} ] = [ \begin{matrix}25 - 4 \cdot 5 \\ 41 - 4 \cdot 11 \\ - 19 - 4 \cdot 4\end{matrix} ] \\ = [ \begin{matrix}5 \\ - 3 \\ - 35\end{matrix} ]\end{matrix} \qquad ( 33 )$$

Flag is set to 1 at step S13.

Another iteration is then carried out, wherein p is set to 3 at step S6, and the following expression is considered at step S7:

$$arg = arg min \{ Q ( 3 ) , - Q ( 3 ) , - R ( 3 , 3 ) \cdot \frac{4}{2} \} \\ arg = arg min \{ - 35 , 35 , - 9 \cdot \frac{4}{2} \} \\ arg = arg min \{ - 35 , 35 , - 18 \} \qquad ( 34 )$$

Therefore, arg is set to 1, the decision block of step S8 directs control to step S9, and steps S9 and S10 set h and Q as set out below:

$$\begin{matrix}h \text{:} [ \begin{matrix}0 \\ 4 \\ 0\end{matrix} ] {\to }^{becomes} [ \begin{matrix}0 \\ 4 \\ 0 + d\end{matrix} ] = [ \begin{matrix}0 \\ 4 \\ 4\end{matrix} ] & ( 35 ) \\ \begin{matrix}Q \text{:} [ \begin{matrix}5 \\ - 3 \\ - 35\end{matrix} ] {\to }^{becomes} [ \begin{matrix}5 + d \cdot R ( 3 , 1 ) \\ - 3 + d \cdot R ( 3 , 2 ) \\ - 35 + d \cdot R ( 3 , 3 )\end{matrix} ] = [ \begin{matrix}5 + 4 \cdot - 2 \\ - 3 + 4 \cdot 4 \\ - 35 + 4 \cdot 9\end{matrix} ] \\ = [ \begin{matrix}- 3 \\ 13 \\ 1\end{matrix} ]\end{matrix} & ( 36 )\end{matrix}$$

Given that p=N and Flag=1, p is reset (step S17) and control passes to S5. For each of the three values ofp steps S6 to. S14 are executed. On each occasion, arg=3 and no updates take place. The individual expressions considered by step S7 during each iteration are not set out in full, although they can be readily deduced from the information presented above.

Given that Flag=0, the algorithm continues for the next value of m.

Execution of the algorithm then continues in the manner outlined above, for each bit of the solution vector elements in turn.

The values of h after each iteration through the solution vector elements are set out below. It should be noted that iteration number referred to here is equivalent to a cumulative iteration count instead of the bit by bit iteration count it described above.

$$[ \begin{matrix}Iteration \text{:} & 0 & 1 & 2 & 3 & 4 & 5 & 6 & 7 & 8 & 9 & 10 \\ 1 st element \text{:} & 0 & 0 & 0 & 0 & 0 & 0 & 0 & 1 & 1 & 1 & 1 \\ 2 nd element \text{:} & 0 & 8 & 8 & 4 & 4 & 2 & 2 & 2 & 2 & 2 & 2 \\ 3 rd element \text{:} & 0 & 0 & 0 & 4 & 4 & 4 & 4 & 5 & 5 & 5 & 5\end{matrix} ]$$

FIG. 2 is a graph showing the value of each solution vector element after each iteration. A first line 1 represents changes to the first solution vector element, h(1), a second line 2 represents changes to the second solution vector element h(2), and a third line 3 represents changes to the third solution vector element h(3).

Solving the set of equations set out at (2) above in a conventional way yields

$$h = [ \begin{matrix}1 \\ 2 \\ 5\end{matrix} ] \qquad ( 37 )$$

Thus, it can be seen that the algorithm effectively solves the system of equations after seven passes through the solution vector elements.

The error in the values of h after each iteration is shown below:

$$[ \begin{matrix}Iteration \text{:} & 0 & 1 & 2 & 3 & 4 & 5 & 6 & 7 & 8 & 9 & 10 \\ 1 st element \text{:} & - 1 & - 1 & - 1 & - 1 & - 1 & - 1 & - 1 & 0 & 0 & 0 & 0 \\ 2 nd element \text{:} & - 2 & 6 & 6 & 2 & 2 & 0 & 0 & 0 & 0 & 0 & 0 \\ 3 rd element \text{:} & - 5 & - 5 & - 5 & - 1 & - 1 & - 1 & - 1 & 0 & 0 & 0 & 0\end{matrix} ]$$

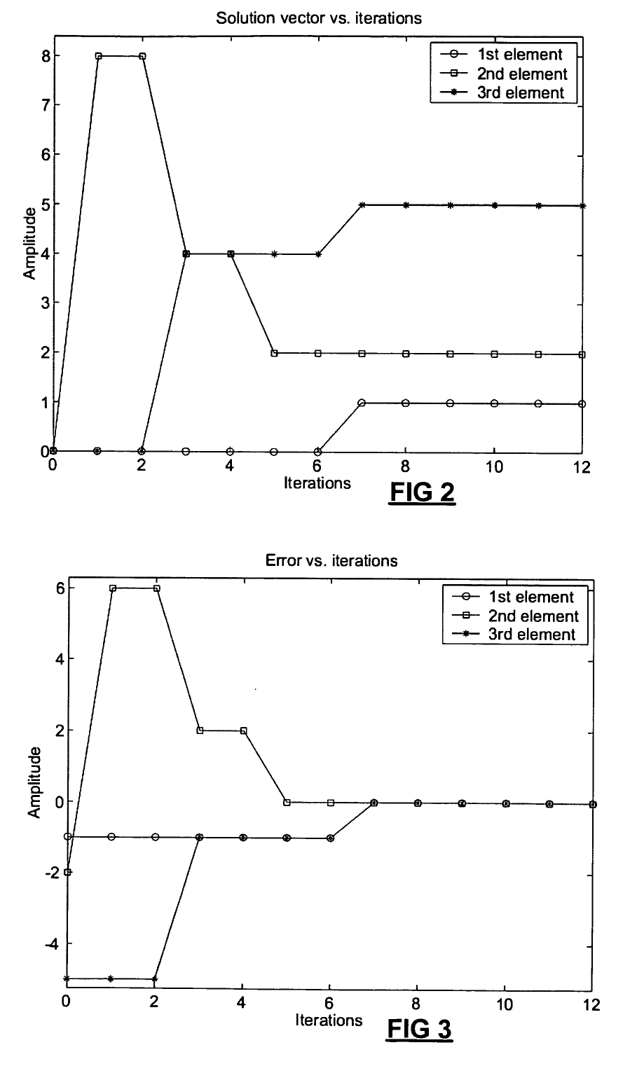

These values are plotted in the graph of FIG. 3, where a first line 4 represents changes to the error of the first solution vector element, h(1), a second line 5 represents changes to the error of the second solution vector element h(2), and a third line 6 represents changes to the error of the third solution vector element h(3). It can be seen that errors diminish as the algorithm proceeds.

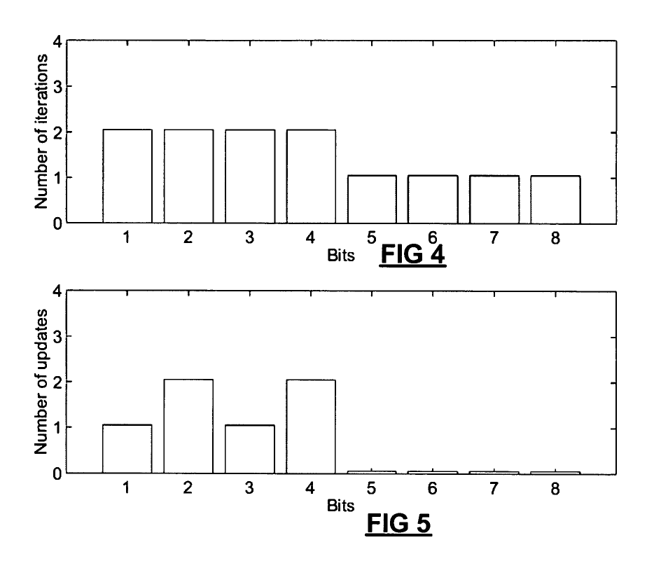

FIG. 4 is a graph showing the number of iterations carried out for each bit, i.e. the value of it when processing of each bit m has been completed. FIG. 5 shows the number of updates made to the solution vector h and auxiliary vector Q for each bit m.

As described above, the auxiliary vector Q is updated as the algorithm progresses. The values of Q after each update of the vector Q and the solution vector h are set out below:

$$[ \begin{matrix}Update & 0 & 1 & 2 & 3 & 4 & 5 & 6 \\ 1 st element & - 15 & 25 & 5 & - 3 & - 13 & 2 & 0 \\ 2 nd element & - 47 & 41 & - 3 & 13 & - 9 & - 4 & 0 \\ 3 rd element & - 51 & - 19 & - 35 & 1 & - 7 & - 9 & 0\end{matrix} ]$$

As a further example, consider the system of equations set out below:

15x+5y−2z=15

5x+11y+4z=−37

−2x+4y+9z=−55 (38)

In this case the accurate solution of the equations is:

$$h = [ \begin{matrix}1 \\ - 2 \\ - 5\end{matrix} ] \qquad ( 39 )$$

It should also be noted that the value H is now equal to 256. Other parameters of the algorithm remain unchanged.

The value of the solution vector after each pass of the algorithm is set out below. Again, it can be seen that the algorithm correctly solves the system of equations.

$$\begin{matrix}[ \begin{matrix}Iteration \text{:} & 0 & 1 & 2 & 3 & 4 & 5 & 6 & 7 & 8 & 9 & 10 & 11 & 12 \\ 1 st element \text{:} & 0 & 0 & 0 & 0 & 0 & 0 & 0 & 0 & 0 & 0 & 0 & 1 & 1 \\ 2 nd element \text{:} & 0 & 0 & 0 & 0 & 0 & 0 & 0 & 0 & 0 & - 2 & - 2 & - 2 & - 2 \\ 3 rd element \text{:} & 0 & 0 & 0 & 0 & 0 & - 8 & - 8 & - 8 & - 6 & - 6 & - 6 & - 5 & - 5\end{matrix} ] & ( 40 )\end{matrix}$$

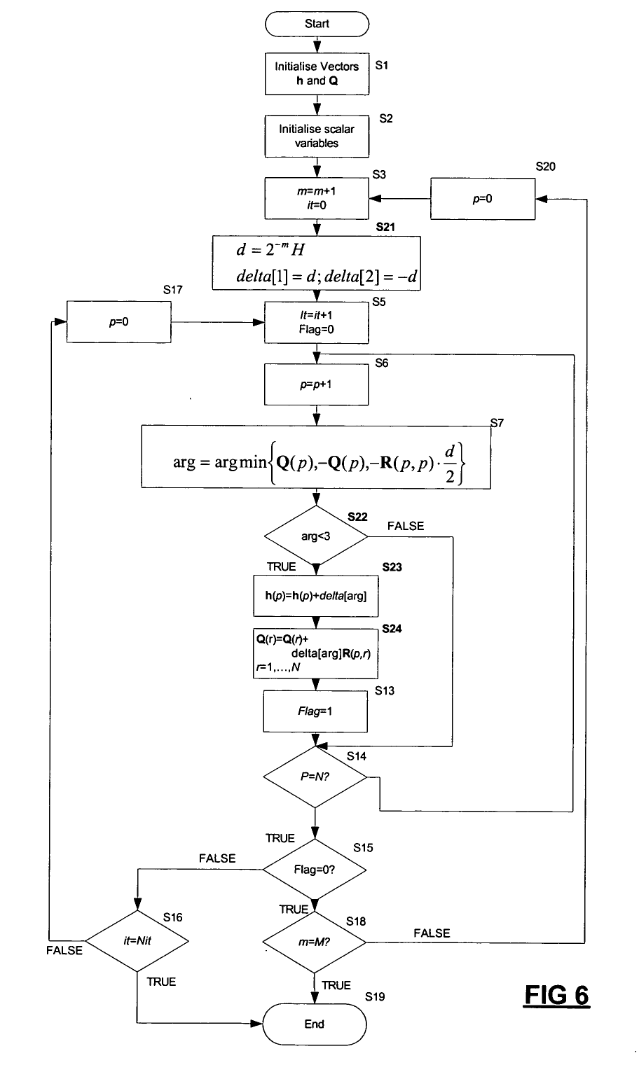

FIG. 6 shows a variant to the algorithm described above with reference to FIG. 1. Many steps of FIG. 6 are identical to steps of FIG. 1. Such steps are identified by like reference numerals in both FIG. 1 and FIG. 6. Only steps which differ from FIG. 1 are described in further detail below.

In FIG. 6, Step S4 of FIG. 1 is replaced by step S21. It can be seen that in addition to setting d in accordance with equation (6):

d=2^{-m}H (6)

a two element array delta is established as follows:

delta[1]=d (41)

delta[2]=−d (42)

In FIG. 1 step S8 determines the value of arg (i.e. 1, 2 or 3) and chooses a different action in dependence upon the value. In FIG. 6, step S8 is replaced with a single comparison at step S22:

arg<3 (43)

If the condition returns false, it can be determined that arg=3 (given that arg can only ever take values of ‘1’, ‘2’, and ‘3’). Therefore in accordance with the algorithm of FIG. 1, FIG. 6 shows that if the condition is false, no updates to h or Q are made, and control passes to step S14 as in FIG. 1.

If the condition of step S22 of FIG. 6 is satisfied, it can be deduced that arg=1 or arg=2. In FIG. 1, if arg=1, steps S9 and S10 update h and Q using expressions including d. Similarly, if arg=2, steps S11 and S12 update h and Q using expressions including −d.

In the variant of the algorithm shown in FIG. 6, the steps S9 and S11 of FIG. 1 are replaced with a single step S23, and similarly steps S10 and S12 are replaced with a single step S24. Both of steps S23 and S24 involve the array delta and more particularly the element arg of the array delta.

Step S23 updates h according to equation (44) and step S24 updates Q according to equation (45).

h(p)=h(p)+delta(arg) (44)

Q(r)=Q(r)+delta(arg)·R(p,r),∀r:r=1, . . . ,N (45)

Given that the first element of delta contains d and the second element contains −d, it can be seen that equations (44) and (45) correctly correspond to equivalent operations of the algorithm of FIG. 1.

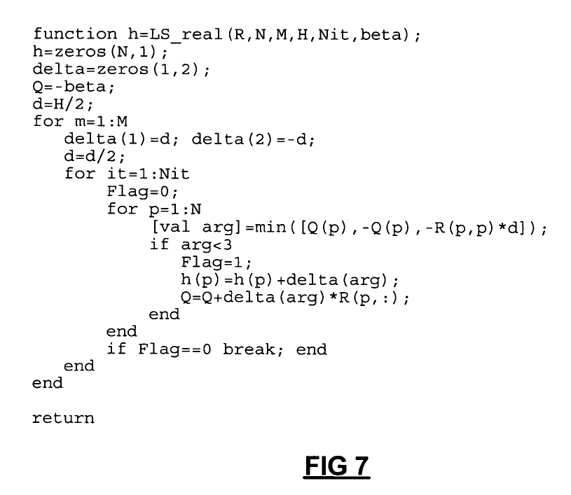

FIG. 7 shows MATLAB® source code for implementing the algorithm illustrated in FIG. 6.

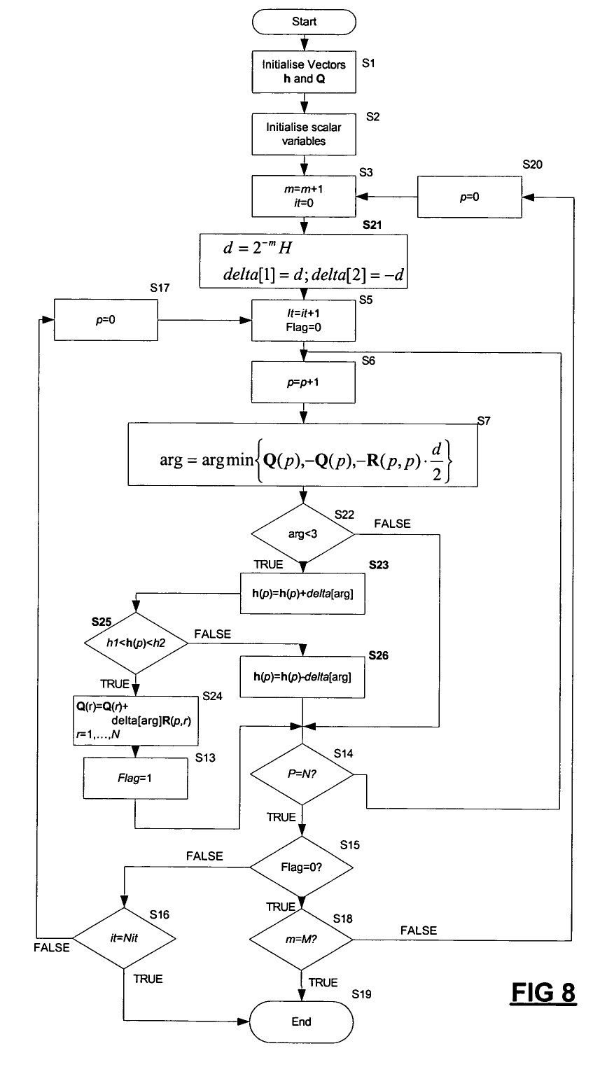

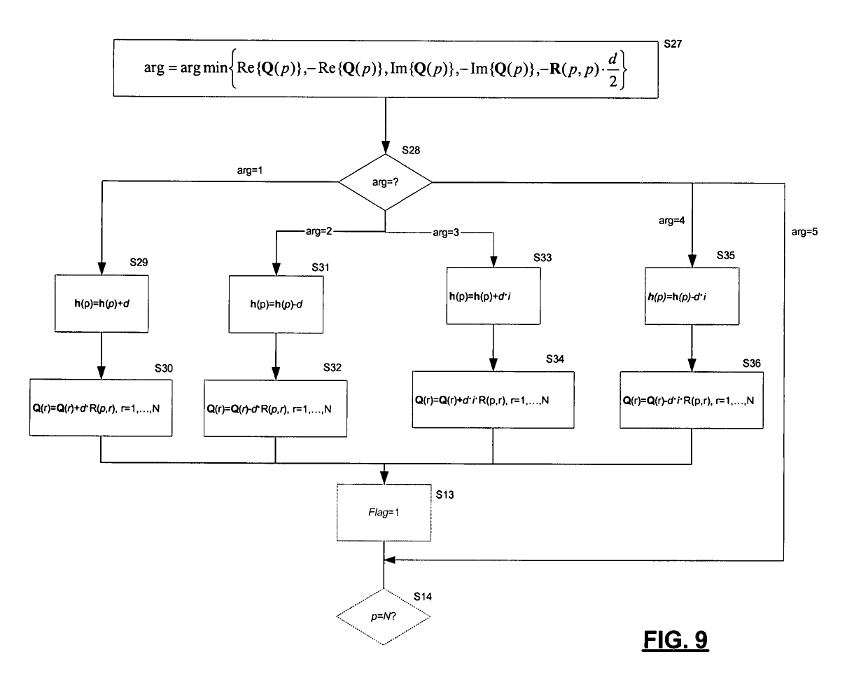

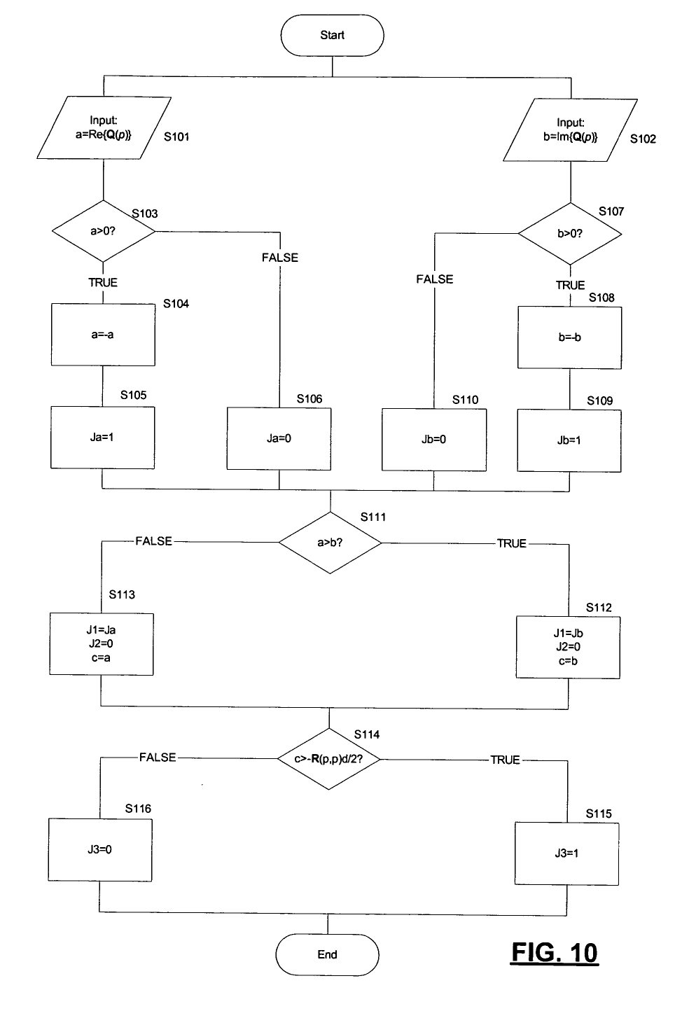

FIG. 8 is a flow chart showing a further variant to the algorithm described above. The algorithm of FIG. 8 is intended to be used where upper and lower bounds are to be enforced upon elements of the solution vector h. For example, it may be known that the solutions lie between +5 and −5, and it may therefore speed up execution of the algorithm if only values in this range are considered.

FIG. 8 illustrates an algorithm where all values h(p) of the solution vector h are constrained with the bounds of equation (46):

h₁<h(p)<h₂ (46)

Before execution of the algorithm constants h₁ and h₂ are established. The establishment of these constants is not illustrated in the flowchart of FIG. 8. Steps of FIG. 8 which are identical to steps of FIG. 6 are identified by like reference numerals in both figures. Only steps which are different between the two Figures are described in further detail below.

Having updated h(p) at step S23, a test is executed at a decision block of step S25 to ensure that newly set value of h(p) lies between the bounds specified in equation (46). If the new value of h(p) satisfies equation (46), the algorithm proceeds to update the auxiliary vector Q at S24 and to update Flag at step S13 as described above with reference to FIG. 6.

If step S25 determines that the newly set value of h(p) does not satisfy equation (46), h(p) is again updated at step S26. This updating reverses the update of step S23, such that h(p) is equal to the value before execution of step S23. Therefore, h(p) has not been updated (because the attempted update did not satisfy equation (46)), Flag is not set to ‘1’, and execution of the algorithm continues at step S14.

In yet a further embodiment of the present invention, the constants h₁ and h₂ of the embodiment of FIG. 8 are replaced by vectors h₁ and h₂ both of which have a length equal to the solution vector h. The vector h₁ contains a lower bound for each element of the solution vector, and the vector h₂ contains an upper bound for each element of the solution vector. Thus, the condition of step S25 becomes:

h₁(p)<h(p)<h₂(p) (46)

The embodiments of the present invention described above are concerned with the application of the algorithm to systems of equations which have real valued solutions. The present invention is also applicable to the solution of systems of equations having complex valued solutions, and the application of the invention to such systems of equations is described below.

Consider the system of equations set out below:

(a₁+a₂i)x+(b₁+b₂i)y+(c₁+c₂i)z=A₁+A₂i

(d₁+d₂i)x+(e₁+e₂i)y+(f₁+f₂i)z=B₁+B₂i

(g₁+g₂i)x+(h₁+h₂i)y+(j₁+j₂i)z=C₁+C₂i (47)

where each of the unknown variables x, y and z is a complex number defined as follows:

x=x₁+x₂i

y=Y₁+y₂i

z=z₁+z₂i (48)

and

i=\sqrt{−1}

From equation (1) above, the system of equations (47) can be expressed as follows:

$$\begin{matrix}R = [ \begin{matrix}{a}_{1} + {a}_{2} i & {b}_{1} + {b}_{2} i & {c}_{1} + {c}_{2} i \\ {d}_{1} + {d}_{2} i & {e}_{1} + {e}_{2} i & {f}_{1} + {f}_{2} i \\ {g}_{1} + {g}_{2} i & {h}_{1} + {h}_{2} i & {j}_{1} + {j}_{2} i\end{matrix} ] & ( 49 ) \\ h = [ \begin{matrix}{x}_{1} + {x}_{2} i \\ {y}_{1} + {y}_{2} i \\ {z}_{1} + {z}_{2} i\end{matrix} ] & ( 50 ) \\ β = [ \begin{matrix}{A}_{1} + {A}_{2} i \\ {B}_{1} + {B}_{2} i \\ {C}_{1} + {C}_{2} i\end{matrix} ] & ( 51 )\end{matrix}$$

To solve the system of equations, a matrix A, and vectors b, and c are created from the data set out above. A is a 2N by 2N real-valued coefficient matrix, b is a real-valued solution vector of length 2N, and c is a real-valued right hand side vector of length 2N, where N is the number of unknown variables (i.e. N=3 in this example).

A, b, and c are set as described below:

A(2m−1,2n−1)=Re{R(m,n)}

A(2m,2n)=Re{R(m,n)}

A(2m−1,2n)=Im{R(m,n)}

A(2m,2n−1)=−Im{R(m,n)} (52)

b(2n−1)=Re{h(n)}

b(2n)=Im{h(n)} (53)

c(2n−1)=Re{β(n)}

c(2n)=Im{β(n)} (54)

Where Re{ } is a function returning the real coefficient of a complex number, and Im{ } is a function returning the imaginary coefficient of a complex number.

Thus, in the case of equations (47), A, is set as follows:

$$A = [ \begin{matrix}{a}_{1} & {a}_{2} & {b}_{1} & {b}_{2} & {c}_{1} & {c}_{2} \\ - {a}_{2} & {a}_{1} & - {b}_{2} & {b}_{1} & - {c}_{2} & {c}_{1} \\ {d}_{1} & {d}_{2} & {e}_{1} & {e}_{2} & {f}_{1} & {f}_{2} \\ - {d}_{2} & {d}_{1} & - {e}_{2} & {e}_{1} & - {f}_{2} & {f}_{1} \\ {g}_{1} & {g}_{2} & {h}_{1} & {h}_{2} & {j}_{1} & {j}_{2} \\ - {g}_{2} & {g}_{1} & - {h}_{2} & {h}_{1} & - {j}_{2} & {j}_{1}\end{matrix} ] \qquad ( 55 )$$

The present invention is often used to solve normal equations. Where normal equations are solved, the matrix A is such that:

b₁=d₁ a₁>0

b₂=−d₂ e₁>0

f₁=h₁ j₁>0

f₂=−h₂ a₂=0

c₁=g₁ e₂=0

c₂=−g₂ j₂=0 (55a)

The vectors b and c are set as follows:

$$\begin{matrix}b = [ \begin{matrix}{x}_{1} \\ {x}_{2} \\ {y}_{1} \\ {y}_{2} \\ {z}_{1} \\ {z}_{2}\end{matrix} ] & ( 56 ) \\ c = [ \begin{matrix}{A}_{1} \\ {A}_{2} \\ {B}_{1} \\ {B}_{2} \\ {C}_{1} \\ {C}_{2}\end{matrix} ] & ( 57 )\end{matrix}$$

Having created the vectors a and b and the matrix A set out above, the methods for solving real valued equations set out above with reference to FIGS. 1, 6 and 8 can be used where:

R=A

h=b

β=c (58)

Values of the solution vector h set by the algorithm can then be used to determine both the real and imaginary components of the complex numbers x, y and z, and to create the complex valued solutions.

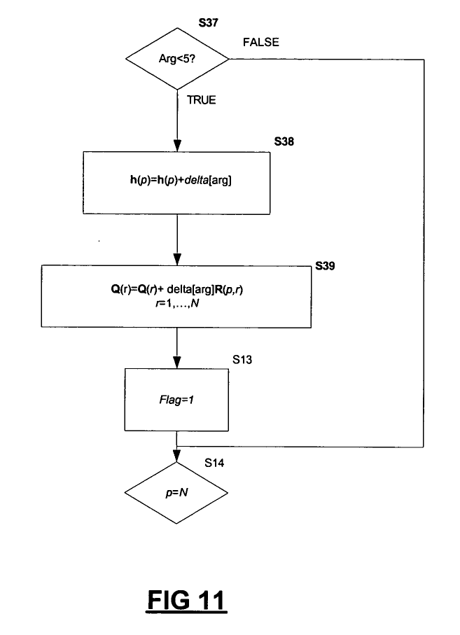

In alternative embodiments of the present invention, the algorithms described above are modified such that the algorithm operates directly on R, h and β as set out in equations (49) to (51) above. These modifications are now described with reference to the flow chart of FIG. 9.

The algorithm used to solve equations involving complex numbers is based upon that of FIG. 1, but steps S7 to S12 are replaced by the steps shown in FIG. 9. Step S27 of FIG. 9 replaces step S7 of FIG. 1, step S28 of FIG. 9 replaces step S8 of FIG. 1, and steps S29 to S36 replace steps S9 to S12 of FIG. 1. Steps S13 and S14 are identical to the eqivilent steps of FIG. 1 and are shown in dotted lines. They are included in FIG. 9 for the sake of clarity.

Referring to FIG. 9, at step S27, the following expression is evaluated:

$$\begin{matrix}arg = argmin \{ Re \{ Q ( p ) \} , - Re \{ Q ( p ) \} , Im \{ Q ( p ) \} , R ( p , p ) \cdot \frac{d}{2} \} \\ where & ( 59 ) \\ argmin = \{ \begin{matrix}1 , & if \{ min ( Re \{ Q ( p ) \} , - Re \{ Q ( p ) \} , Im \{ Q ( p ) \} , - Im \{ Q ( p ) \} , - R ( p , p ) \cdot \frac{d}{2} ) = Re \{ Q ( p ) \} \} \\ 2 , & if \{ min ( Re \{ Q ( p ) \} , - Re \{ Q ( p ) \} , Im \{ Q ( p ) \} , - Im \{ Q ( p ) \} , - R ( p , p ) \cdot \frac{d}{2} ) = - Re \{ Q ( p ) \} \} \\ 3 , & if \{ min ( Re \{ Q ( p ) \} , - Re \{ Q ( p ) \} , Im \{ Q ( p ) \} , - Im \{ Q ( p ) \} , - R ( p , p ) \cdot \frac{d}{2} ) = Im \{ Q ( p ) \} \} \\ 4 , & if \{ min ( Re \{ Q ( p ) \} , - Re \{ Q ( p ) \} , Im \{ Q ( p ) \} , - Im \{ Q ( p ) \} , - R ( p , p ) \cdot \frac{d}{2} ) = - Im \{ Q ( p ) \} \} \\ 5 , & if \{ min ( Re \{ Q ( p ) \} , - Re \{ Q ( p ) \} , Im \{ Q ( p ) \} , - Im \{ Q ( p ) \} , - R ( p , p ) \cdot \frac{d}{2} ) = - R \{ Q ( p ) \} \}\end{matrix} & ( 60 )\end{matrix}$$

and Re{ } and Im{ } are as defined above.

The value of arg set at step S27 is checked at the decision block of S28. This determines the update (if any) to be made to the elements of the solution vector h and the auxiliary vector Q.

If arg is 1, then the element p of the solution vector h currently under consideration is updated as follows at step S29:

h(p)=h(p)+d (61)

Equation (61) means that the real part of h(p) is increased by d.

All elements of the auxiliary vector Q are also updated, in accordance with equation (62) at step S30.

Q(r)=Q(r)+dR(p,r),∀r:1≦r≦N (62)

If arg is 2, then the element p of the solution vector h currently under consideration is updated as follows at step S31:

h(p)=h(p)−d (63)

Equation (64) means that the real part of h(p) is decreased by d.

All elements of the auxiliary vector Q are also updated, in accordance with equation (62) at step S32.

Q(r)=Q(r)−dR(p,r),∀r:1≦r≦N (64)

If arg is 3, then the element p of the solution vector h currently under consideration is updated as follows at step S33:

h(p)=h(p)+i·d (65)

Equation (65) means that the imaginary part of h(p) is increased by d.

All elements of the auxiliary vector Q are also updated, in accordance with equation (66) at step S34.

Q(r)=Q(r)+d·i·R(p,r),∀r:1≦r≦N (66)

If arg is 4, then the element p of the solution vector h currently under consideration is updated as follows at step S35:

h(p)=h(p)−i·d (65a)

Equation (65a) means that the imaginary part of h(p) is decreased by d.

All elements of the auxiliary vector Q are also updated at step S36, in accordance with equation (66a).

Q(r)=Q(r)−d·i·R(p,r),∀r:1≦r≦N (66a)

If arg=1, 2, 3, or 4, Flag is set to ‘1’ at step S13, control then passes to step S14 and the algorithm proceeds as described above with reference to FIG. 1.

If arg=5, no updates are made to h or Q and control passes to step S14, and the algorithm proceeds as described above.

Step S27 described above, requires the minimum of five values to be identified so as to determine the next course of action:

$$min \{ Re \{ Q ( p ) \} , - Re \{ Q ( p ) \} , Im \{ Q ( p ) \} , - Im \{ Q ( p ) \} , - R ( p , p ) \cdot \frac{d}{2} \}$$

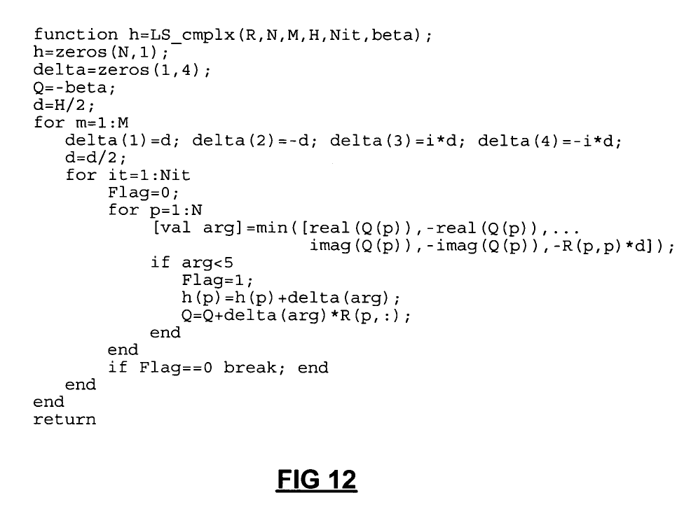

a method for finding this minimum, and efficiently identifying the correct action (at step S28 of FIG. 9), is now described with reference to the flowchart of FIG. 10

The algorithm takes as input two values a and b. a is input at a step S101 and is set to be equal to the real part of Q(p), and b is input at a step S102 and is set to be equal to the imaginary part of Q(p).

A decision block S103 determines whether or not a is greater than 0. If a is positive, a is set to be equal to the negative of its current value at a step S104, and a variable Ja is set to ‘1’ at step S105. If a is not positive, the variable Ja is set to ‘0’ at step S106.

b is processed in a similar manner. Step S107 checks whether b is positive. If b is positive, it is set to the negative of its current value at step S108, and a variable Jb is set to ‘1’ at step S109. If b is not positive, Jb is set to ‘0’ at step S110.

Thus after execution of steps S101 to S110, Ja is set to ‘1’ if the input value of a was positive, and ‘0’ if the input value of a was not positive. Jb is similarly set. Given the action of steps S104 and S108, it can be seen that both a and b will now not be positive.

At step S111 a check is made to determine whether a is greater than b. If this condition is true a variable J1 is set to be equal to Jb, a variable J2 is set to ‘0’ and a variable c is set to be equal to b. This is accomplished by step S112. If the condition of step S111 is false, a variable J1 is set to be equal to Ja, a variable J2 is set to ‘0’ and c is set to be equal to a. This is accomplished by step S113.

At step S114, a check is made to determined whether or not c is greater than −R(p,p)d/2. If this condition returns true, a variable J3 is set to be equal to ‘1’ at step S115. If this condition is false, the variable J3 is set to be equal to ‘0’ at the step S116.

The method of FIG. 10 is such that after execution of all steps, the variables J1, J2 and J3 are set as follows:

J3=1 [symbol] no update necessary

J3=0 [symbol] update necessary

J2=1 [symbol] update to imaginary part necessary

J2=0 [symbol] update to real part necessary

J1=1 [symbol] update should comprise subtraction

J1=0 [symbol] update should comprise addition

It will be appreciated that the modifications made to the algorithm of FIG. 1, as illustrated in FIGS. 6 and 8 can similarly made to the algorithm of FIG. 9. For example, the algorithm of FIG. 9 can be implemented using an array delta, similar to that used in FIG. 6, where:

delta[1]=d;

delta[2]=−d,

delta[3]=d·i;

delta[4]=−d·i;

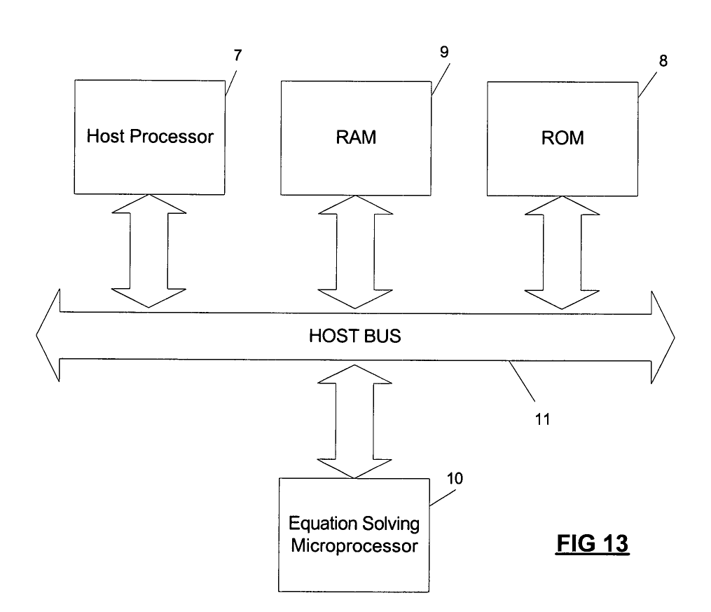

Having established delta in this way, the algorithm can proceed by simply adding the appropriate element of delta to the appropriate element or elements of h or Q as described above. FIG. 11 shows this variant of the algorithm of FIG. 9 where steps S28 to S36 are replaced by steps S37 to S39. It will be appreciated that additionally the array delta must be initialised and updated after each update of d in accordance with equation (67). This is not shown in FIG. 11. FIG. 12 shows a MATLAB program implementing the algorithm illustrated in FIG. 11.

The description presented above has illustrated various implementations of algorithms in accordance with the invention. It will be appreciated that various amendments can be made to these algorithms without departing from the invention.

For example, in the description set out above execution ends when the number of iterations it for any particular bit m reaches a predetermined limit Nit. It will be appreciated that execution need not end in this circumstance. Instead, a timer t may be set to ‘0’ each time m is updated, and execution can end if this timer exceeds a predetermined time threshold.

The vectors h and Q need not necessarily be initialised as indicated above. Indeed, the initial value for h should usually be substantially centrally positioned in the range −H to H in which solutions are being sought, so as to obtain quick convergence. In some embodiments of the present invention the auxiliary vector need not be created. Instead the vector β is used directly, and is updated in a manner similar to the manner described above for vector Q, although it will be appreciated that different updates will be required. Suitable updates for such embodiments of the invention are set out in the derivation of the algorithm presented below.

It has been described above that d is updated by dividing the previous value of d by two. This is preferred because considerable benefits are achieved because computations involving multiplication of d can be carried out using efficient bit shift operations in place of relatively inefficient multiplication operations. However, it will be appreciated that alternative methods for updating d may be used in some embodiments of the invention. For example, if d is updated by division by a power of two such as four or eight, computations can still be efficiently implemented by carrying out two or three bit shifts instead of the single bit shifts required when d is updated by division by two.

In preferred embodiments of the present invention, each value of the solution vector h is represented by a fixed point binary word. This is particularly beneficial given that mathematical operations can typically be carried out more efficiently using fixed point arithmetic. Furthermore, a fixed point representation is likely to be acceptable because the different unknown variables are likely to have an approximately equal magnitude.

In circumstances where a fixed point representation is inappropriate for the solution vector values, a conventional floating point representation can be used. Although the algorithm will operate more slowly with floating point values than with fixed point values, the algorithm still offers very favourable performance as compared with other methods for solving linear equations.

It will be appreciated that the algorithm described above can be implemented in software or hardware. A software implementation will typically comprise appropriate source code executing on an appropriate microprocessor. For example, as shown in FIGS. 7 and 12, code can be created in MATLAB which is compiled to create object code which is specified in the instruction set of a microprocessor. Although MATLAB provides a convenient implementation for the algorithms of the invention, it will be appreciated that the algorithms could instead be coded in any one of the large number of widely available computer programming languages.

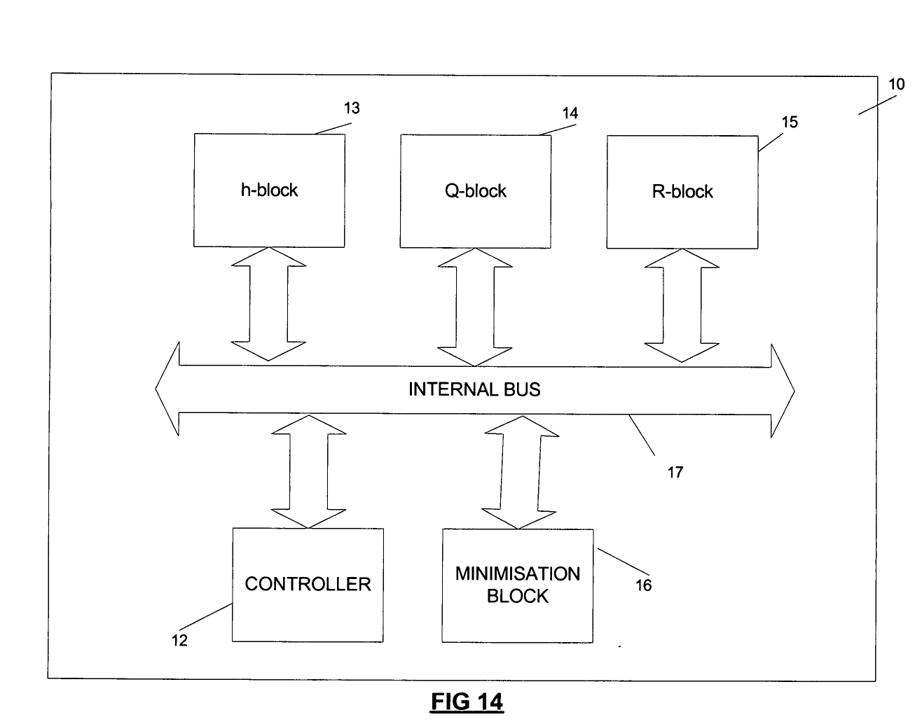

A hardware implementation of the algorithm can either be provided by configuration of appropriate reconfigurable hardware, such as an application specific integrated circuit (ASIC), field programmable gate array (FPGA), or a configurable computer (CC), or alternatively by a bespoke microprocessor built to implement the algorithm. FIGS. 13 to 18 illustrate a device and microprocessor configured to solve linear equations.

FIG. 13 schematically illustrates the general architecture of a device configured to solve linear equations. The device comprises a host processor 7 which is a general purpose microprocessor of known form configured to control operation of the device by running appropriate program code. This program code can be stored on a non volatile storage device 8 (e.g ROM or FLASH memory) and read by the general purpose microprocessor 7 when it is to be executed. Alternatively the program code can be copied to a volatile memory 9 (e.g RAM) prior to execution. In order to solve linear equations using the method of the invention, the device comprises an equation solving microprocessor 10, operation of which is controlled by the host processor 7. The aforementioned components of the device are connected together by a host bus 11.

FIG. 14 illustrates the architecture of the equation solving microprocessor 10 in further detail. The equation solving microprocessor 10 comprises a controller 12, the function of which is to control operation of the equation solving microprocessor 10. The equation solving microprocessor 10 further comprises a h-block 13, which stores and updates the solution vector h of the algorithm, a Q-block 14 which stores and updates the auxiliary vector Q of the algorithm, and a R-block 15 which stores the coeffient matrix R used by the algorithm. The equation solving microprocessor 10 also comprises a minimisation block 16 which finds the minimum of a number of values. Components of the equation solving microprocessor 10 are connected together by an internal bus 17, along which control instructions and data can pass.

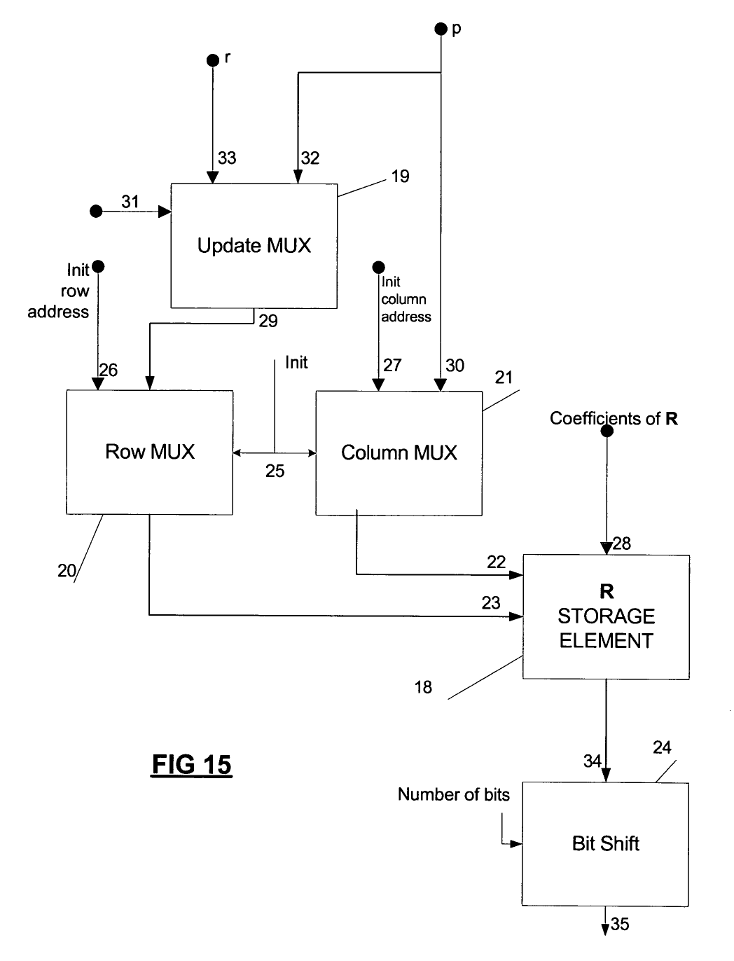

FIG. 15 shows the structure of R-block 15 in further detail. The R-block 15 comprises a storage element 18 which stores the elements of the coefficient matrix R. The R-block also comprises multiplexers 19, 20 and 21 which generate a column address signal 22, and a row address signal 23 for reading data from and writing data to the storage element 18 in the manner described below. Finally, the R-block comprises a bit-shift element 24 which can left-shift a value presented at its input by a value determined by the current value of d.

The multiplexers 19, 20, 21 generate address signals as follows. The row multiplexer and the column multiplexer 21 each have selection inputs connected to a common input line 25 which can carry an initialisation signal Init which is typically received from the controller 12 (FIG. 14). If an initialisation signal is received, this indicates that data is to be written to the storage element 18 representing the coefficients of the equations which are to be solved. In this case the row multiplexer should generate a row address 23 which is equal to the input row address 26, and similarly the column multiplexer 21 should generate a column address 22 which is equal to the input column address 27. During initialisation, the row address 26 and column address 27 will typically count through elements of the matrix R writing data provided to the storage element 18 on input line 28 to the appropriate element of the storage element 18.

When initialisation has been completed, the Init signal will no longer be received by the selection input of the multiplexers 20, 21, and therefore the row address is determined by the input 29 to the row multiplexer 20 and the column address is determined by the input 30 to the column multiplexer 21. The input 30 is the value p of the algorithm as described above. The input 29 is connected to the update multiplexer 19 whose output is dependent upon whether values of R are being read for purposes of analysis (e.g step S7 of FIG. 1) or update of Q (e.g. steps S10 and S12 of FIG. 1). The update multiplexer 19 has a selection input 31 which indicates either update or analysis. This can conveniently be achieved, for example, by a single bit input where ‘0’ indicates update and ‘1’ indicates analysis.

If R is being read for purposes of analysis (i.e. the selection input 31 is set to ‘1’), then the element R(p,p) is required (see step S7 of FIG. 1). Therefore, update multiplexer output 29 is set to be equal to the input 32 which is equal to p, and the row multiplexer 20 subsequently generates a row address 23 equal to p.

If R is being read for purposes of update of the auxiliary vector Q (i.e. selection input is set to ‘0’) R(p,r) is required (see steps S10 and S12 of FIG. 1). Therefore the update multiplexer output 29 is equal to the input 33 which is set to be equal to r, and the row multiplexer 20 subsequently generates a row address 23 equal to r.

In either case, the column multiplexer 21 generates a column address 22 which is equal to p.

From the preceding description, it can be seen that the multiplexers 19, 20 and 21, act together to ensure that the correct row address 23 and column address 22 are sent to the storage element 18. Having read the appropriate element of R from the storage element 18, the output needs to be multiplied by d regardless of whether it is being used for update or analysis (see steps S7, S10 and S12 of FIG. 1). As described above, this can be achieved by a bit shift (assuming that d is a power of 2), the number of bits to shift being determined by the expression:

log₂d (68)

which is passed to an input 34 of the bit shift block 24. The output 35 from the bit shift block 24 is then correctly set as follows:

d·R(p,r), if update (68a)

d·R(p,p), if analysis (68b)

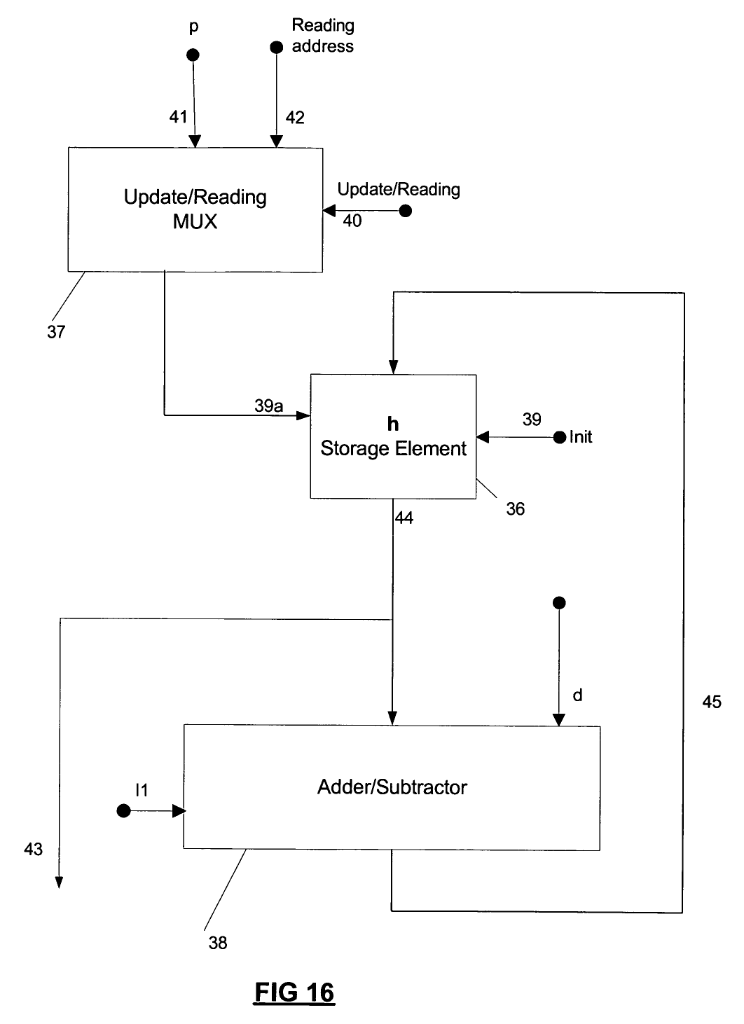

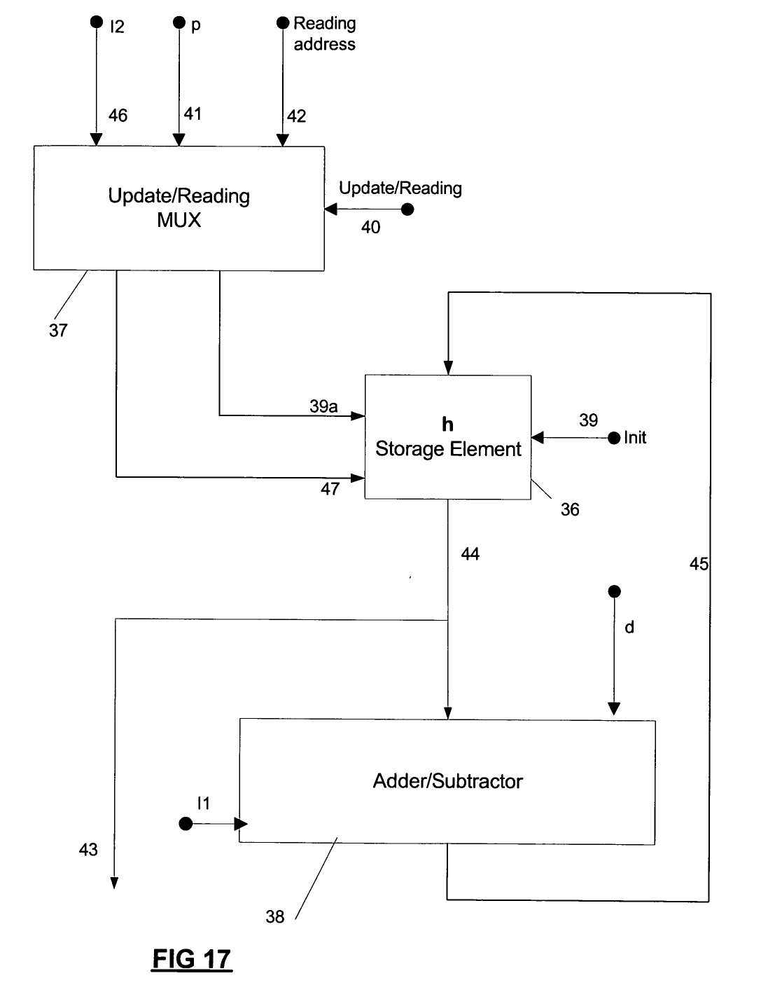

FIG. 16 illustrates the h-block 13 of FIG. 14 in further detail. The h-block comprises a storage element 36 for storing elements of the solution vector h, an update/reading multiplexer 37, and an adder-subtractor 38.

To initialise elements of the solution vector, an initialisation signal 39 is input to the storage element 36. Upon receipt of this signal, all elements of the solution vector h are initialised to ‘0’.

The update/reading multiplexer 37 sends an appropriate address 39a to the storage element 36. The address 39a sent to the storage element 36 is determined by the signal provided to a selection input 40 of the multiplexer 37. If the selection input 40 is set to update, the address p provided at input 41 becomes the address 39a.

If the selection input 40 is set to read (i.e. the values of h are being read to obtain the solution of the equations), a read address 42 input to the multiplxer 37 becomes the address 39. In the case of a read operation, the input read address will count through all elements of h in turn, and each element will be transmitted to the internal bus 17 of the equation solving microprocessor 10 in turn.

In the case of an update operation, a single value of p is provided to the multiplexer 37, and an input signal I₁ is provided to the adder/subtractor 38. The signal I₁ indicates whether the element of the solution vector h(p) is to be updated by adding d or subtracting d. Upon receipt of the address 39, the storage element 36 outputs the appropriate element to the adder/subtractor 38 along a line 44. By analysing the signal I₁ the adder/subtractor 38 can determine whether its output should be set to h(p)+d or h(p)−d. The appropriate expression is calculated, and written back to the storage element 36 along a line 45.

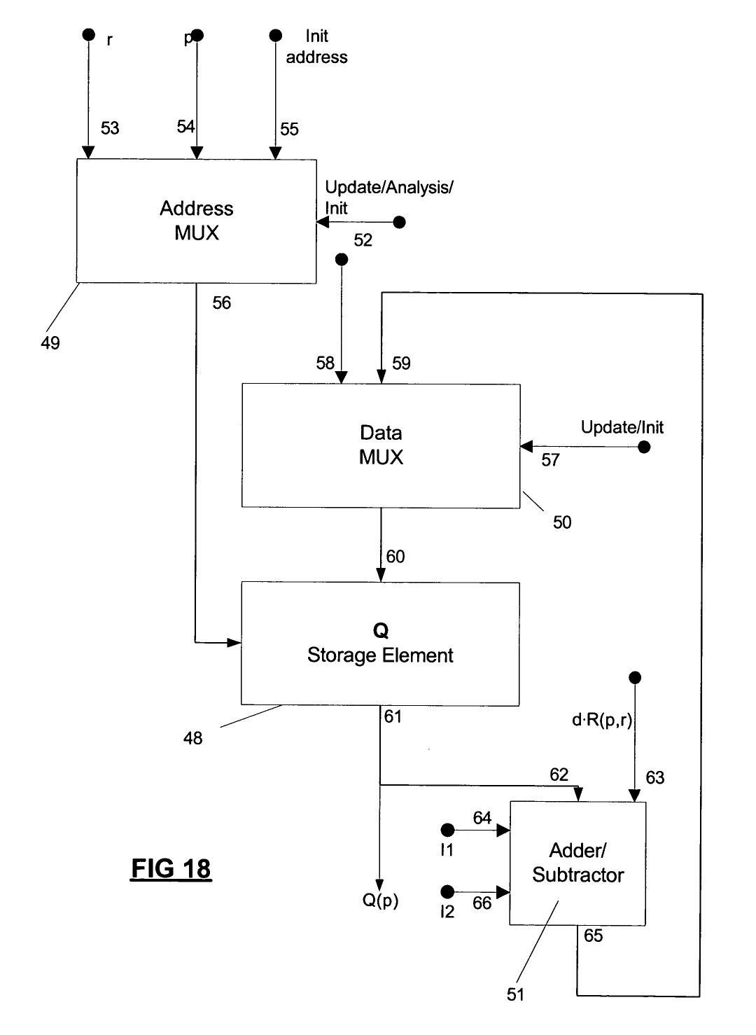

FIG. 17 shows how the h-block 16 can be implemented when the algorithm is used to solve equations having complex values (for example using the algorithm of FIGS. 10, 11 or 12). It can be seen that in addition to the components illustrated in FIG. 16, the update/read multiplexer 37 has an additional input 46 which carries a signal I₂. This signal is sent to the storage element 36 along a line 47 along with the address p when the selection input is set to update. The signal I₂ indicates whether the update should be made to the real part or the imaginary part of h(p).

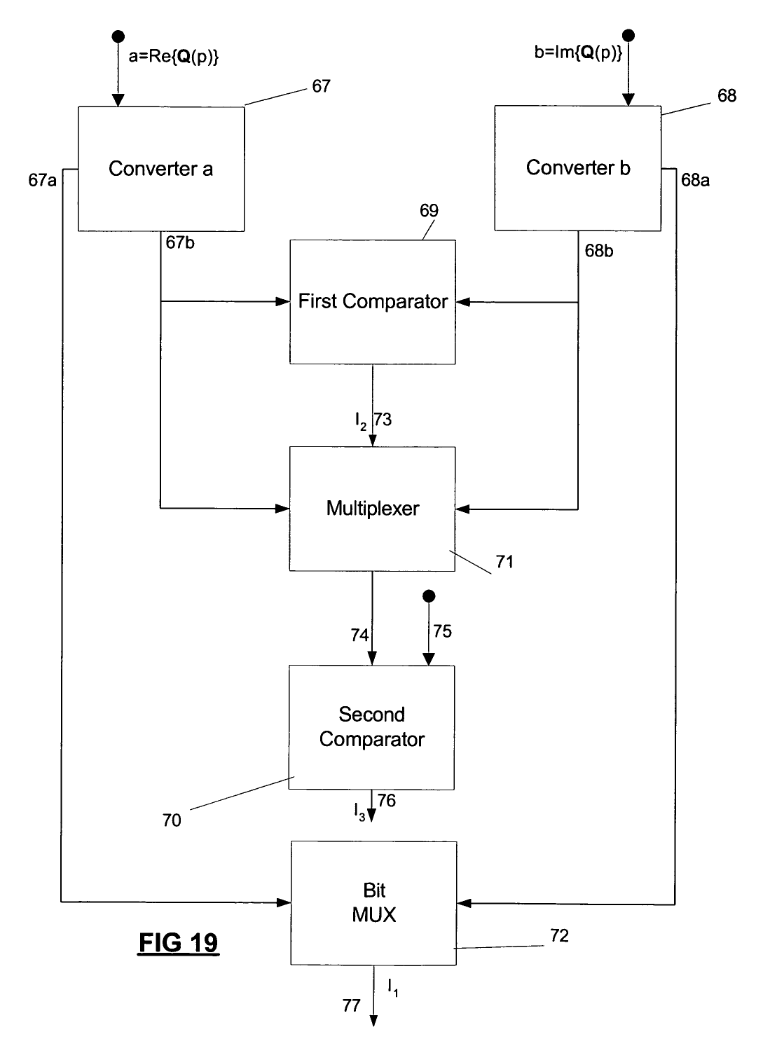

FIG. 18 illustrates the Q-block 14 of FIG. 14 in further detail. It can be seen that the Q-block comprises a storage element 48 for storing the vector Q, an address multiplexer 49, a data multiplexer 50 and an adder/subtractor 51.

The address multiplexer 49 has a selection input 52 which selects update, analysis, or initialisation mode. The address multiplexer 49 also has three data inputs, a first data input 53 carries the value r used in the algorithm, a second data input 54 carries the value p used in the algorithm, and a third data input 55 carries initialisation address data.

When the selection input 52 of the address multiplexer 49 is set to initialise, an output 56 of the address multiplexer carries the initialisation address supplied at the third input 55 of the address multiplexer. When the selection input 52 is set to update, the output 56 carries the value r supplied at the first input 53 of the address multiplexer 49. When the selection input 52 is set to analysis, the output 56 of the address multiplexer 49 is set to the value p supplied at the second input 54 to the address multiplexer 49. The output 56 of the address multiplexer is passed to the storage element 48 as an address for reading or writing data.

Data is written to the storage element 48 only in the update and initialisation modes. Therefore, the data multiplexer 50, has a selection input 57 having two recognised values, update and initialise (it will be appreciated that in practice this selection input may be common with the selection input 52 of the address multiplexer 49, although the behaviour of the data multiplexer is not well defined when the selection input is set to analysis).

The data multiplexer 50 comprises a first data input 58 carrying initialisation data (elements of the vector β) and a second data input 59 carrying update data. When the selection input 57 of the data multiplexer 50 is set to initialise, data from the first data input 58 is provided at the output 60 of the data multiplexer 50. When the selection input 57 is set to update, data from the second data input 59 is provided at the output 60.

In operation, when the selection inputs of both multiplexers 49, 50 are set to initialise, a sequence of addresses (counting through all elements of the vector Q) are provided at the third data input 55 of the address multiplexer 49. In synchronisation with these addresses, the appropriate data is provided at the first data input 58 of the data multiplexer 50. The data and addresses are provided to the storage element 48, and the storage element is then set to contain the appropriate elements of the vector Q.

When the selection inputs of both multiplexers 49, 50 are set to update, the address r is provided to the storage element 48 by the multiplexer 49. The appropriate entry from the storage element 48, Q(r) is provided at an output 61 of the storage element, and passed to a first input 62 of the adder/subtractor 51. A second input 63 of the adder/subtractor is set to d·R(p,r) (provided by the R-block 15 of FIG. 14). The adder/subtractor also includes an input 64 carrying a signal I₁ which indicates whether the adder/subractor 51 should perform an addition or subtraction operation. On receipt of appropriate data at its inputs an output 65 of the adder/subtractor is set to the output of the operation preformed, and this data is fed to the data multiplexer 50. Given that the selection input 57 is set to update, the data provided at the input 59 is provided to the output 60 of the data multiplexer, and from there to the storage element 48 where it is written to the element of Q specified by the address 56.

Where the algorithm is being implemented to solve complex valued equations, the adder/subtractor comprises a further input 66 carring an signal I₂ which indicates whether the update should be applied to the real part or the imaginary part of the appropriate element of the vector Q.

In analysis mode, the Q-block is required to provide a current value of Q(p), with no update functions being needed. The data multiplexer 50 is therefore not involved with the analysis operation. The address multiplexer 49 provides the address p provided at its second input 54 to the storage element 48. The appropriate value of Q(p) is read from the storage element 48 and provided at the output 61 of the storage element 48.

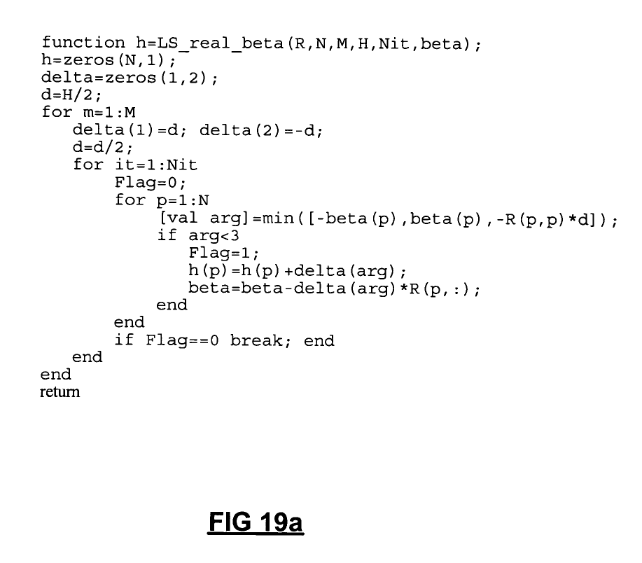

FIG. 19 provides an implementation for the minimisation block 16 of FIG. 14. This implementation corresponds to that illustrated in FIG. 10, and is therefore configured for use in algorithms solving equations having complex valued solutions. The minimisation block comprises first and second converter blocks 67, 68, first and second comparators 69, 70 and first and second multiplexers 71, 72.

Input data is provided to the first and second converter blocks 67, 68. The first converter block 67 takes as input the real part of a value Q(p), and the second converter block 68 takes as input the imaginary part of the value Q(p). The converter blocks 67 and 68 provide two outputs, a first output 67a, 68a indicates the sign of the input data, and second output 67b, 68b indicates the modulus of the input data. The modulus outputs 67b, 68b are input to the first comparator 69, which generates a signal I₂ which at an output 73. The signal I₂ is defined as being ‘0’ if the value provided at output 67b is greater than that provided at 68b, and ‘1’ if the value provided at output 68b is greater than or equal to that provided at output 67b.

The values provided at outpus 67b and 68b are also provided to the first multiplexer 71, along with the output value 73 created by the first comparator 69. The output 73 of the first comparator acts as a selection input to the first multiplexer 71. The first multiplexer 71 then acts to provide the larger of the values 67b, 68b at its output 74.

The output 74 of the multiplexer 71 is input to the second comparator 70, along with the value d·R(p,p) at an input 75, which is computed by the R-block 16 of FIG. 15. The second comparator 70 then produces an output 76 which is a signal I₃ which is set such that 13 is set to ‘0’ if the input 74 greater than the input 75, and ‘1’ if the imputer 75 is greater than or equal to the input 74.

The second multiplexer 72 is a bit multiplexer taking as input the signs of the input data generated by the converter blocks 67, 68. In dependence upon the value of the signal I₂ output from the first comparator 69, the multiplexer generates an output 77 which is a signal I₁.

The signals I₁, I₂ and I₃ can together be used to determine what update (if any) should be made to the elements of Q and h. I₃ indicates whether or not the current iteration is successful. If I₃ is equal to ‘0’, the element h(p) is updated, and all elements of Q are updated. If I₃ is equal to ‘1’, no updates are necessary.

I₂ indicates whether the real or the imaginary part of the appropriate elements should be updated. If I₂ is equal to ‘0’ the real part of the appropriate values is updated, while if I₂ is equal to ‘1’ the imaginary part of the appropriate values is updated. I₁ indicates whether the update should comprise addition or subtraction. If I₁ is set to ‘0’, addition is used, and if I₁ is set to ‘1’, subtraction is used.

Having described the structure and function of the individual components of the equation solving microprocessor 10 (FIG. 14), operation of the processor is now described.

To perform initialisation, the equation solving microprocessor receives a signal to cause initialisation, for example from the host processor (FIG. 13). The controller 12 of the equation solving microprocessor then generates an appropriate internal initialisation signal which is communicated to all blocks of the equation solving microprocessor, via the internal bus 17. Upon receipt of this signal the h-block 13, the Q-block 14 and the R-block 15 perform initialisation as described above. The data required for initialisation may be located in a predefined read only memory, or an address where the data is to be found may be provided to the controller 12 for onward transmission to the appropriate block. Parameters used by the algorithm (e.g. N, M and Nit) can either be provided to the controller, or alternatively specified within the microprocessor 10.

When initialisation is complete, the controller begins executing an algorithm in accordance with the invention using the blocks of the microprocessor 10 to update values of h and Q as appropriate. In some embodiments of the invention data that is required to be passed between blocks of the microprocessor is passed directly between blocks, under the control of the sending and/or receiving block. In alternative embodiments of the invention all data is passed between blocks as directed by the controller 12. When the controller determines that the equations have been solved, such that the vector h contains the solution of the equations, the vector h can then be copied from the storage element 36 (FIGS. 16 and 17) to an appropriate location within the device, where the solutions can be used as required.

It will be appreciated that although a specific hardware implementation of algorithms of the invention has been described above, numerous modifications could be made to the implementation while remaining within the scope and spirit of the invention. Such modifications will be readily apparent to those of ordinary skill in the art.

The preceding description has described algorithms in accordance with the invention, and hardware suitable for implementing such algorithms. The mathematical basis of algorithms in accordance with the invention is now described.

To aid understanding of the invention, the known co-ordinate descent optimisation method for minimising a function of many variables is presented. The co-ordinate descent optimisation method seeks to find:

min{J(h)} (69)

where J is a function of many variables; and

h is an N-dimensional vector containing the variables.

Thus we want to find the value of h when the function J is a minimum.

In many circumstances the elements of h have a maximum amplitude H. Therefore, the minimisation problem is considered for a subset of values of h defined by equations (70) and (71).

hεU (70)

where:

U={h(m):1≦m≦NΛ|h(m)|<H}; (71)

where:

h(m) are elements of the vector h and H is a known number such that H>0.

Define a vector ei where the ith coordinate is ‘1’, and all other coordinates are ‘0’. Let h₀ be an initial value of the solution vector h and let α₀ be an initial value of the step size parameter (that is d in the algorithms described above).

hₖ is defined to be the value of the solution vector h after some number of iterations k, where k is a positive integer. αₖ is the step size parameter after k iterations.

A vector pₖ is also defined, according to the equation:

pₖ=eᵢ_{ₖ} (72)

where:

iₖ=k−N(div(K,N))+1 (73)

where div (A,B) is a function whose result is defined as the integer part of result of dividing A by B.

It can be seen from equation (73) that iₖ will repeatedly count from 1 to N as k is increased. This results in values of p cycling through e₁ to e_{N}: p, e₁,p₂=e₂, . . . , p_{N}=e_{N},p_{N+1}=e₁,p_{N+2}=e₂, . . . ,p_{2N}=e_{N} (74)

The value of the function J is calculated at the point h=hₖ+αₖpₖ and two conditions are checked:

hₖ+αₖpₖεU (75)

J(hₖ+αₖpₖ)<J(hₖ) (76)

If the conditions of equations (75) and (76) are satisfied, then the solution vector h is pdated as follows:

hₖ₊₁=hₖ+αₖpₖ. (77)

Given that that update involves a scalar multiple of the vector pₖ and given also that pₖ is a vector containing only a single non-zero element, it can be seen that equation (77) means that hₖ+1 will be identical to hk save for a single element.

The step size parameter is not updated at this stage, as indicated by equation (78)

αₖ₊₁=αₖ (78)

If the conditions of equations of (75) and (76) are not satisfied, the value of the function J is calculated at the point h=hₖ−αₖpₖ and two conditions are again checked:

hₖ−αₖpₖεU (79)

J(hₖ−αₖpₖ)<J(hₖ) (80)

If the conditions of equations (79) and (80) are satisfied, then the solution vector h is updated as follows:

hₖ₊₁=hₖ−αₖpₖ. (81)

Again, given that that update involves a scalar multiple of the vector pₖ and given also that pₖ is a vector containing only a single non-zero element, it can be seen that equation (81) means that hₖ₊₁ will be identical to hₖ save for a single element.

The step size parameter is not updated at this stage, as indicated by equation (82)

αₖ₊₁aₖ (82)

The kth iteration is considered to be successful if either the conditions of equations (75) and (76) or equations (79) and (80) are satisfied. If neither of these conditions are satisfied, the iteration is considered to be unsuccessful.

αₖ is updated according to equation (83):

$${α}_{k + 1} = \{ \begin{matrix}λ {α}_{k} , if {i}_{k} = N ⋀ {h}_{k} = {h}_{k - N + 1} \\ {α}_{k} , otherwise\end{matrix} \qquad ( 83 )$$

where λ is a parameter of the algorithm, and is such that 0<λ<1

The condition of equation (83) means that if the last N iterations involve no successful updates (i.e. the value of h has not changed), the step size parameter is updated by multiplication by λ. If however there is at least one update during the previous N iterations, the step size parameter is not updated. It should be recalled that N is defined to be the number of elements in the solution vector h, and it can therefore be seen that h is updated only when all elements have been processed and no update has occurred.

The method described above is generally known as co-ordinate descent optimisation.

It is known that for some arbitrary function J, the method converges to find the value of h for which the function is a minimum, providing that the function J is convex and differentiable on U, providing that α₀>0, and 0<λ<1 and providing that h₀ εU. This result is shown, for example, in Vasiliev, F. P.: “numerical methods for solutions of optimisation problems”, Nauka, Moscow 1988 (published in Russian), the contents of which is herein incorporated by reference.

It is often necessary to solve the linear least squares problem. The linear least squares roblem is concerned with the minimisation of the function J specified in equation (84):

J(h)=|Zh−d|²=(Zh−d)^{T}(Zh−d) (84)

with respect to an unknown vector h, where Z is a known M×N matrix, d is a known vector of length N, and denotes the transpose of a matrix.

This is discussed in Sayed, A. H., and Kailath, K.: “Recursive least-squares adaptive filters”, The Digital Signal Processing Handbook, CRC Press, IEEE Press 1998, pages 21.1 to 21.37, which discussion is herein incorporated by reference.

It can be shown that the minimisation of the function of equation (84) is equivalent to minimisation of a quadratic function.

Equation (84) can be rewritten as:

J(h)=h^{T}Z^{T}Zh−h^{T}Z^{T}d−d^{T}Zh+d^{T}d (85)

by multiplying out the bracketed expressions of equation (84).

Given that the purpose of the method is to minimise J with respect to h it can be concluded that the term d^{T}d of equation (85) will not effect the minimisation process, and therefore can be removed from the expression without affecting the minimum value. Therefore minimisation of equation (85) is equivalent to minimisation of equation (86):

J(h)=h^{T}Z^{T}Zh−h^{T}Z^{T}d−d^{T}Zh (86)

A matrix R is defined according to equation (87):

R=Z^{T}Z (87)

A matrix β is defined according to equation (88):

β=Z^{T}d (88)

Equation (86) can then be rewritten using R and β as shown in equation (89):

J(h)=h^{T}Rh−h^{T}β−β^{T}h (89)

Simplifying this expression yields:

J(h)=h^{T}Rh−2h^{T}β (90)

The expression h^{T}Rh can be rewritten in terms of the elements of h, and R as follows, using the definitions of matrix multiplication, and the matrix transpose operation:

$${h}^{T} Rh = {\sum }_{m = 1}^{N} {\sum }_{n = 1}^{N} R ( m , n ) h ( m ) h ( n ) \qquad ( 91 )$$

Similarly the expression h^{T}β can be written in form of equation (92):

$${h}^{T} β = {\sum }_{n = 1}^{N} β ( n ) h ( n ) \qquad ( 92 )$$

Substituting equations (91) and (92) into equation (90) yields:

$$J ( h ) = {\sum }_{m = 1}^{N} {\sum }_{n = 1}^{N} R ( m , n ) h ( m ) h ( n ) - 2 {\sum }_{n = 1}^{N} β ( n ) h ( n ) \qquad ( 93 )$$

It can be seen that equation (93) is a quadratic function of h. Thus it can be seen that solving the linear least squares problem is equivalent to minimisation of the function of equation (93). Furthermore, it is also known that solving a system of linear equations of the form of equation (1):

Rh=β (1)

is equivalent to minimisation of the function of equation (93), for any set of normal linear equations. This is explained in, for example, Moon, Todd K., and Stirling, Wynn C.: “Mathematical methods and algorithms for signal processing”, Prentice Hall, 2000, section 3.4. “Matrix representations of least-squares problems”, pages 138-139. This explanation is incorporated herein by reference.

Given that many sets of linear equations occurring the electronics and physics are normal linear equations, minimisation of the function of equation (93) has wide applicability in solving linear equations.

The explanation presented above has set out a method for minimising a function J using the co-ordinate descent optimisation method. The material presented above has also set out the relationship between the minimisation of equation (93) and a set of linear equations of the form of equation (1).

The present inventors have surprisingly discovered that applying the known co- ordinate descent method to the minimisation of equation (93) provides a particularly efficient method for solving linear equations.

Minimisation of the function of equation (94) is considered:

$$J ( h ) = \frac{1}{2} {\sum }_{m = 1}^{N} {\sum }_{n = 1}^{N} R ( m , n ) h ( m ) h ( n ) - {\sum }_{n = 1}^{N} β ( n ) h ( n ) \qquad ( 94 )$$

This minimisation process finds values for the elements of h which minimise the function J(h). The matrix R and the vector β are known. It is known that the function of equation (94) is convex and differentiable. This is shown in Vasiliev, F. P.: “Numerical methods for solutions of optimisation problems”, Nauka, Moscow 1988 (published in Russian), page 345, which explanation is incorporated herein by reference. Therefore, as explained above, the co-ordinate descent optimisation method can be used to find the minimum value of the function J.

During operation of the co-ordinate descent optimisation method, the following expressions are computed:

ΔJ(hₖ)=J(hₖ+αₖeᵢ_{ₖ})−J(hₖ) (95)

and

ΔJ(hₖ)=J(hₖαₖeᵢ_{ₖ})−J(hₖ) (96)

It can be seen that equation (95) relates to the condition of equation (76) set out above, while equation (96) relates to the condition of equation (80) set out above.

The inequality of equation (97) is also considered:

ΔJ(hₖ)<0 (97)

It can be recalled that the values of the vector eᵢ_{ₖ} has elements defined by:

$${[ {ⅇ}_{{i}_{k}} ]}_{i} = \{ \begin{matrix}1 if i - {i}_{k} \\ 0 otherwise\end{matrix} \qquad ( 98 )$$

Also, it is known that the matrix R is symmetric, given that the system of equations is normal. Therefore, substituting equation (94) into equation (95) yields:

$$Δ J ( {h}_{k} ) = \frac{{α}_{k}}{2} [ - 2 β ( i ) + 2 {\sum }_{m = 1}^{N} {h}^{( k )} ( m ) R ( m , i ) + {α}_{k} R ( i , i ) ] \qquad ( 99 )$$

where h^{(k)}(m) are elements of the vector hₖ.

If a vector Q is defined as:

$$Q ( i ) = - 2 β ( i ) + 2 {\sum }_{m = 1}^{N} {h}^{( k )} ( m ) R ( m , i ) \qquad ( 100 )$$

then equation (99) can be written as:

$$Δ J ( {h}_{k} ) = \frac{{α}_{k}}{2} [ Q ( i ) + {α}_{k} R ( i , i ) ] \qquad ( 101 )$$

Given that αₖ>0, from equation (101), equation (95) can be rewritten as:

αₖR(i,i)<−Q(i) (102)

Similarly, equation (96) can be rewritten as:

αₖR(i,i)>Q(i) (103)

An auxiliary vector Qₖ is defined as the vector Q after the kth iteration. If the (k+1)th iteration is not successful, then elements of h and Q can be updated as follows:

hₖ₊1=hₖ (104)

and

Qₖ₊1=Qₖ (105)

the (k+1)th iteration is successful, then elements of h and Q are updated as ollows:

h^{(k+1)}(i)=h^{(k)}(i)±αₖ (106)

Q^{(k+1)}(n)=Q^{(k)}(n)±2αₖR(n,i),n=1, . . . ,N (107)

The vector h can be initialised to a vector h₀ where

h₀(n)=0, n=1, . . . ,N (108)

Then, from equation (100), elements of Q are initialised as follows:

Q₀(n)=−2β(n), n=1, . . . ,N (109)

That is, each element of Q is set to be the negative of the corresponding element of β multiplied by two.

Thus, the solution vector h is initialised to contain all ‘0’ values, while the auxiliary vector Q is initialised to be the negative of the vector β.

As described above, multiplication operations may be avoided by setting H in accordance with equation (110):

H=2^{P+M}^{_{b}} (110)

where M_{b} is a positive integer, and P is any integer. α₀ is initialised to be

$$\frac{H}{2}$$

and λ is initialised to be

$$\frac{1}{2} .$$

The multiplications described above can then be replaced by bit shift operations.

The algorithms described thus far have used an auxiliary vector Q which is intialised n accordance with equation (4):

Q=−β (4)

However, some embodiments of the invention use β itself as an auxiliary vector. In such embodiments of the invention, the auxiliary vector update rule of equation (107) above becomes:

β^{(k+1)}(n)=β^{(k)}(n)±αₖR(n,i),n=1, . . . , N (111)

Similarly, the inequalities of equations (102) and (103) become:

αₖR(i,i)<2β(i) (112)

and:

αₖR(i,i)>−2β(i) (113)

FIG. 19a shows MATLAB source code for an algorithm which uses β in place of Q. This algorithm is based upon that of FIG. 7, but the code has been amended as set out above.

The step size parameter αₖ is updated if N consecutive iterations are not successful. At every update of αₖ, αₖ is decreased by a factor of two. The algorithm described above is therefore referred to as the dichotomous coordinate descent algorithm for the solution of linear equations.

From the description set out above, it can be observed that the algorithms of the invention solve linear equations by minimisation of an appropriate quadratic function. It has been explained above that it is known that such minimisation can be mployed to solve normal linear equations. However, it should be noted that the resent invention is not limited simply to normal linear equations, but is instead pplicable to a wider class of linear equations.

In the methods described above, the elements of the solution vector h are analysed in predetermined order (i.e. from element ‘1’ to element N). However, it will be appreciated that elements of the solution vector h can be analysed in any convenient manner. For example, the values of h can be sorted on the basis of some corresponding auxiliary value (e.g. a corresponding element of the vector Q), and elements of the solution vector h can then be processed in that order. For some applications, ordering elements of the vector h in this way will provide a more rapid convergence, although this must of course be balanced against the computational cost of sorting the elements of h.

It has been explained above that the present invention can be usefully applied in any application in which it is necessary to solve linear equations. Two such applications are now described.

In a multiuser Code Division Multiple Access (CDMA) communications system, a plurality of users transmit data using a common collection of frequencies. A narrow band data signal which a user is to transmit is multiplied by a relatively broad band spreading code. Data is then transmitted using this broad band of frequencies. Each user is allocated a unique spreading code.

A receiver needs to be able to receive data transmitted by a plurality of users simultaneously, each user using his/her respective spreading code. The receiver therefore needs to implement functions which allow the spreading code to be removed from the received data to yield the originally transmitted data. Typically filters are used to extract the spreading code to obtain the transmitted data. It should be noted that the process is complicated by interfering signals from multiple users, and also from different propagation paths which may be followed by different signals.

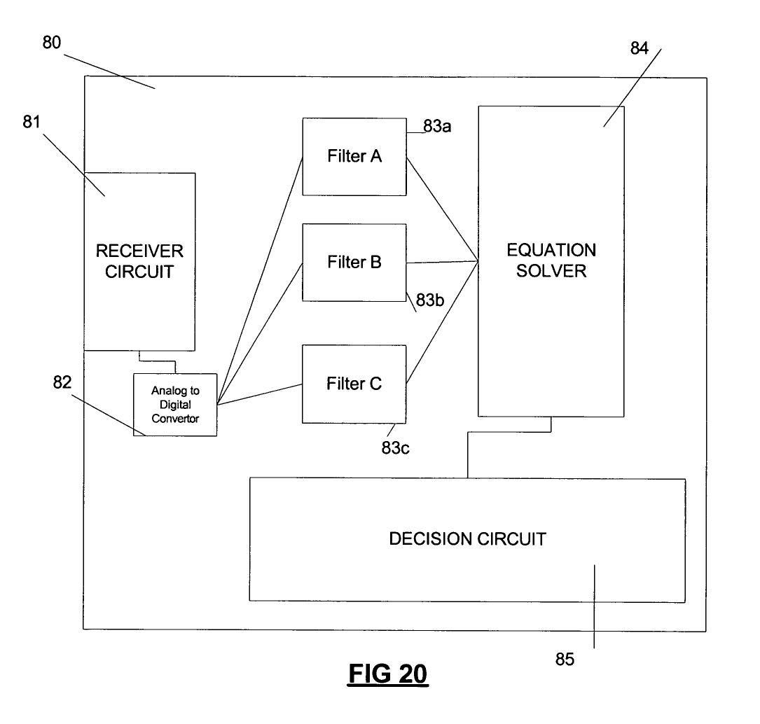

FIG. 20 illustrates a receiver 80 suitable for use in a CDMA communications system. The receiver comprises a receiver circuit 81 including an antenna (not shown), an analog to digital convertor 82, a bank of filters 83a, 83b and 83c, an equation solving circuit 84 and a decision circuit 85.

Spread spectrum signals are received by the receiver circuit 81, and converted into digital data by the analog to digital converter 82. Digital data is then passed to all of the filters 83a, 83b, 83c. Each filter of the bank of filters 83a, 83b, 83c relates to a unique user, and has filter coefficients selected to match the spreading code of that user. It will therefore be appreciated that in practical embodiments a receiver will include more than three filters as is illustrated in FIG. 20.

If a single signal is transmitted at any one time, and this signal travels between a sender and the receiver 80 by a direct path, the output of the filters alone should provide the data which the sender intended to transmit. However, in the more likely and more complicated situation where interference between signals occurs, the outputs of the filters alone will be inconclusive. However, it is known that solving an equation:

Rh=β (114)

where R is the cross correlation matrix of the spreading sequences of all users;

β is a vector containing the filter output values; and

h is a solution vector

will allow the originally transmitted data to be obtained.

In general, for a system involving N users, there will be N filters, and the vector β will therefore have length N, and the matrix R will have size N×N.

The cross correlation matrix R can be defined as

R=S^{T}S (115)

where the matrix S contains the spreading codes, and is defined as follows:

$$S = [ \begin{matrix}{s}_{1} ( 1 ) & {s}_{2} ( 1 ) & ⋯ & {s}_{k} ( 1 ) \\ {s}_{1} ( 2 ) & {s}_{2} ( 2 ) & ⋯ & {s}_{k} ( 2 ) \\ ⋮ & ⋮ & ⋰ & ⋮ \\ {s}_{1} ( m ) & {s}_{2} ( m ) & ⋯ & {s}_{k} ( m )\end{matrix} ] \qquad ( 116 )$$

where sⱼ(i) denotes the ith element of the spreading code for user j.

As has been described above linear equations of the form shown in equation (114) can be solved using an algorithm in accordance with the invention. Therefore, the invention provides a novel multi user receiver apparatus, in which the equation (114) is solved as described above, thereby achieving the considerable performance benefits provided by solving equations in accordance with the invention.

The equation solver 84 of FIG. 20 can either be implemented by means of a computer program carrying out the method of the invention executing on an appropriate microprocessor, or alternatively by means of hardware, such as that described above with reference with FIGS. 14 to 19.

The equation solver provides a vector h as output, and this is input to the decision circuit 85, which then determines the nature of the transmitted data.

It will be appreciated that the cross correlation matrix described with reference to equations (115) and (116) is merely exemplarily. Cross correlation matricies can be created in a variety of different ways which will be known to one skilled in the art. Regardless of how the cross correlation matrix is formed, a system of equations (114) is created which can be solved using methods in accordance with the present invention.

It will also be appreciated that in addition to the components illustrated in FIG. 20 and described above, a CDMA receiver may require other components to function properly. The selection and use of these components will be readily apparent to those of ordinary skill in the art.

The algorithms of the invention can also be employed in adaptive filtering applications such as echo cancellation in a hands free communications system.

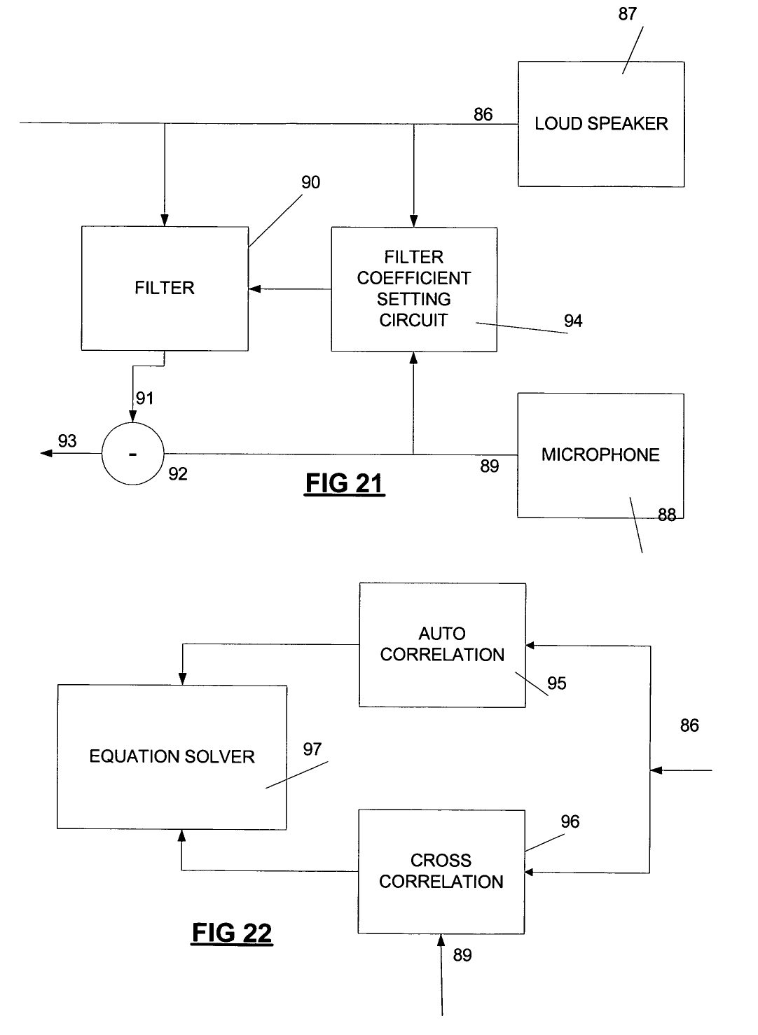

A system of interest in illustrated in FIG. 21. A signal travels along input line 86 and is output through a loudspeaker 87. A further signal such a human voice (not shown) is passed to an input of a microphone 88. It is desirable that the signal at the output 89 of the microphone 88 contains only the human voice signal, and none of the signal output by the loudspeaker 87. However, in practice, some of the signal output by the loudspeaker 87 will be received by the microphone 88 such that the microphone output 89 comprises a combination of the human voice signal and part of the loudspeaker output signal (referred to as “the echo signal”). It is desirable to remove the echo signal present in the microphone output 89.

As shown in FIG. 21, the echo cancellation apparatus comprises a filter 90, which is configured to provide an estimate 91 of the echo signal. This estimate 91 is subtracted from the microphone output signal 89 by a subtractor 92. Therefore, if the echo is accurately estimated, an output 93 of the subtractor will be equal to the human voice signal.

The echo cancellation apparatus comprises a filter coefficient setting circuit 94, which takes as inputs a signal 86 which is input to the loudspeaker and the signal 89 which is output from the microphone. The circuit 94 should generate coefficients to allow the filter 90 to accurately model the echo signal.

FIG. 22 shows the filter coefficient setting circuit 94 in further detail. It can be seen that the circuit comprises an auto correlation element 95, a cross correlation element 965 and an equation solver 97. The auto correlation element 95 finds the auto correlation of the signal 86. The cross correlation element 96 finds the cross correlation between the signal 86 and the signal 89. It is known that when a auto correlation matrix R and a cross correlation vector β have been generated, the optimal filter coefficients h can be found by solving the system of equations:

Rh=β (117)

where the auto correlation matrix R is generated according to the equation:

$$R ( m , n ) = {\sum }_{t = 1}^{T - \vert n - m \vert} x ( t ) x ( t + \vert n - m \vert ) , \\ ∀ m , n \text{:} 1 < m < N ⋀ 1 < n < N \qquad ( 118 )$$

where t=1, . . . , T are discrete time moments;

and the cross correlation vector β is generated according to the equation:

$$β ( n ) = {\sum }_{t = 1}^{T - n - 1} x ( t ) y ( t + n - 1 )$$

where x is the loudspeaker input signal 86 and y is the microphone output signal 89.

An echo cancellation system operating in the manner described above is described in US5062102 (Taguchi).

Having generated a system of equations of the form of equation (117), algorithms in accordance with the present invention can be used to solve linear equations to determine a solution vector h containing optimal filter coefficients. Therefore, referring back to FIG. 22, the equation solver 97 can either be a microprocessor executing code in accordance with one of the algorithms described above, or alternatively hardware suitably configured to implement a suitable algorithm.

It will be appreciated that although this application of the algorithm has been described with reference to echo cancellation, it is widely applicable in all cases where an adaptive filter is required, and where solving a system of linear equations yields appropriate filter coefficients. A suitable example system in which the invention could be beneficially employed is described in WO 00/38319 (Heping).

Applications of the invention to CDMA receivers, and echo cancellers have been described above. However, it will be appreciated that many other applications exist which can benefit by the improved efficiency with which linear equations can be solved in accordance with the invention. For example, the invention can be used in tomographic imaging systems, where a large system of linear equations is solved to generate an image.

Although the present invention has been described above with reference to various preferred embodiments, it will be apparent to a skilled person that modifications lie within the scope and spirit of the present invention.

What is claimed is:

1. A method for solving a system of N linear equations in N unknown variables, the method comprising:
(a) storing an estimate value for each unknown variable;
(b) initialising each estimate value to a predetermined value;
(c) for each estimate value:
(i) determining whether a respective predetermined condition is satisfied; and
(ii) updating the estimate if and only if the respective predetermined condition is satisfied; and
(d) repeating step (c) until each estimate value is sufficiently close to an accurate value of the respective unknown variable.

2. A method according to claim 1, wherein said updating comprises adding a scalar value d to the respective estimate value, or subtracting a scalar value d from the respective estimate value.

3. A method according to claim 2, wherein said scalar value d is updated in a predetermined manner.

4. A method according to claim 3, wherein said scalar value d is updated when and only when step (c) updates no estimate values.

5. A method according to claim 4, wherein said updating divides d by a scalar update value.

6. A method according to claim 5, wherein the scalar update value is equal to a power of two.

7. A method according to claim 6, wherein the scalar update value is equal to two.

8. A method according to claim 1, wherein each of said estimate values is initialised to be equal to zero.

9. A method according to claim 1, wherein the respective predetermined condition for each respective estimate value does not involve the respective estimate value.

10. A method according to claim 2, wherein the method establishes a respective auxiliary value for each estimate value.

11. A method according to claim 10, wherein said auxiliary values form an auxiliary vector Q.

12. A method according to claim 11, wherein said predetermined condition for each respective estimate value involves the respective auxiliary value.

13. A method according to claim 12, wherein a plurality of auxiliary values are associated with each estimate value.

14. A method according to claim 13, wherein the predetermined condition for a respective estimate value involves the minimum amongst the plurality auxiliary values.

15. A method according to claim 14, wherein the minimum value is compared with a threshold value.

16. A method according to claim 15, wherein the condition is satisfied if the minimum value is less than the threshold value.

17. A method according to claim 16, wherein the plurality of auxiliary values for a respective estimate value consist of a first auxiliary value, and second auxiliary value which is the negative of the first auxiliary value.

18. A method according to claim 17, wherein the threshold value for the nth unknown variable is the scalar value d multiplied by the coefficient of the nth unknown variable in the nth equation.

19. A method according to claim 18, wherein one of a plurality of updates is selected in the condition is satisfied.

20. A method according to claim 19, wherein the scalar value d is added to the respective estimate value if the condition is satisfied and minimum value is the first auxiliary value.

21. A method according to claim 19, wherein the scalar value d is subtracted from the respective estimate value if the condition is satisfied and minimum value is the second auxiliary value.

22. A method according to claim 20, wherein the first auxiliary value for the nth unknown variable is initially set to be equal to the negative of the right hand side of the nth equation.

23. A method according to claim 21, wherein the first auxiliary value for the nth unknown variable is initially set to be equal to the negative of the right hand side of the nth equation.

24. A method according to claim 19, wherein the respective first and second auxiliary values are updated if the condition is satisfied.

25. A method according to claim 24, wherein the first and second auxiliary values associated with each estimate value are updated if the condition is satisfied.

26. A method according to claim 25, wherein if the predetermined condition is satisfied for the nth estimate value:
the first auxiliary value for the mth estimate value is updated by:
multiplying the coefficient of the mth unknown variable in the nth equation by the scalar value d; and
adding the result of said multiplication to the first auxiliary value to create a new first estimate auxiliary value, or subtracting the result of said multiplication from the first auxiliary value to create the new first estimate auxiliary value; and
the second auxiliary value for the mth estimate value is updated to be equal to the negative of the new first auxiliary value.

27. A method according to claim 1, wherein each estimate value is represented as a fixed point binary word.

28. A method according to claim 1, wherein each estimate value is a floating point binary word.

29. A method according to claim 1, wherein each estimate value is a complex number.

30. A method according to claim 3, wherein the scalar value d is updated such that the algorithm updates the estimate values in a bitwise manner, beginning with the most significant bit.

31. A method according to claim 4, wherein step (d) is carried out until a predetermined condition is satisfied.

32. A method according to claim 31, wherein said predetermined condition is a maximum number of iterations without an update to the scalar value d.

33. A method according to claim 32, wherein said predetermined condition is a total execution time elapsed without an update to the scalar value d.

34. A method according to claim 1, wherein the accurate solution of the equations is known to lie between upper and lower bounds, and the algorithm seeks a solution between said upper and lower bounds.

35. A method according to claim 34, wherein said estimate values are initialised to a value which is within said upper and lower bounds.

36. A method according to claim 35, wherein said estimate values are initialised to a value positioned at the midpoint of said upper and lower bounds.

37. A computer apparatus for solving a system of N linear equations in N unknown variables, the apparatus comprising:
a program memory containing processor readable instructions; and
a processor for reading and executing the instructions contained in the program memory;
wherein said processor readable instructions comprise instructions controlling the processor to carry out the method according to claim 1.

38. A data carrier carrying computer readable program code to cause a computer to execute procedure in accordance with the method of claim 1.

39. A method for solving a system of N linear equations in N unknown variables, the method comprising:
(a) storing an estimate value for each unknown variable;
(b) initialising each estimate value to a predetermined value;
(c) attempting to update each estimate value using a scalar value d;
(d) updating the scalar value if no updates are made in step (c); and
(e) repeating step (c) and step (d) until each estimate value is sufficiently close to an accurate value of the respective unknown variable.

40. A method according to claim 39, wherein updating said estimate values comprises adding the scalar value d to an estimate value, or subtracting the scalar value d from an estimate value.

41. A method according to claim 40, wherein said updating the scalar value divides the scalar value by a scalar update value.

42. A method according to claim 41, wherein the scalar update value is equal to a power of two.

43. A method according to claim 42, wherein the scalar update value is equal to two.

44. A method according to claim 39, wherein each of said estimate values is initialised to be equal to zero.

45. A method according to claim 39, wherein step (c) comprises:
for each estimate value:
(i) determining whether a respective predetermined condition is satisfied; and
(ii) updating the estimate if and only if the respective predetermined condition is satisfied;

46. A method according to claim 45, wherein the method establishes a respective auxiliary value for each estimate value.

47. A method according to claim 46, wherein said auxiliary values form an auxiliary vector Q.

48. A method according to claim 47, wherein said predetermined condition for each respective estimate value involves the respective auxiliary value.

49. A method according to claim 48, wherein a plurality of auxiliary values are associated with each estimate value.

50. A method according to claim 49, wherein the predetermined condition for a respective estimate value involves the minimum amongst the plurality auxiliary values.

51. A method according to claim 50, wherein the minimum value is compared with a threshold value.

52. A method according to claim 51, wherein the condition is satisfied if the minimum value is less than the threshold value.

53. A method according to claim 52, wherein the plurality of auxiliary values for a respective estimate value consist of a first auxiliary value, and second auxiliary value which is the negative of the first auxiliary value.

54. A method according to claim 53, wherein the threshold value for the nth unknown variable is the scalar value d multiplied by the coefficient of the nth unknown variable in the nth equation.

55. A method according to claim 54, wherein one of a plurality of updates is selected if the condition is satisfied.

56. A method according to claim 55, wherein the scalar value d is added to the respective estimate value if the condition is satisfied and minimum value is the first auxiliary value.

57. A method according to claim 56, wherein the scalar value d is subtracted from the respective estimate value if the condition is satisfied and minimum value is the second auxiliary value.

58. A method according to claim 56, wherein the first auxiliary value for the nth unknown variable is initially set to be equal to the negative of the right hand side of the nth equation.

59. A method according to claim 57, wherein the first auxiliary value for the nth unknown variable is initially set to be equal to the negative of the right hand side of the nth equation.

60. A method according to claim 55, wherein the respective first and second auxiliary values are updated if the condition is satisfied.

61. A method according to claim 60, wherein the first and second auxiliary values associated with each estimate value are updated if the condition is satisfied.

62. A method according to claim 61, wherein if the predetermined condition is satisfied for the nth estimate value:
the first auxiliary value for the mth estimate value is updated by:
multiplying the coefficient of the mth unknown variable in the nth equation by the scalar value d; and
adding the result of said multiplication to the first auxiliary value to create a new first estimate auxiliary value, or subtracting the result of said multiplication from the first auxiliary value to create a new first estimate auxiliary value; and
the second auxiliary value for the mth estimate value is updated to be equal to the negative of the new first auxiliary value.

63. A method according to claim 39, wherein each estimate value is represented as a fixed point binary word.

64. A method according to claim 39, wherein each estimate value is a floating point binary word.

65. A method according to claim 39, wherein each estimate value is a complex number.

66. A method according to claim 39, wherein step (e) is carried out until a predetermined condition is satisfied.

67. A method according to claim 66, wherein said predetermined condition is a maximum number of iterations without an update to the scalar value d.

68. A method according to claim 66, wherein said predetermined condition is a total execution time elapsed without an update to the scalar value d.

69. A method according to claim 39, wherein the accurate solution of the equations is known to lie between upper and lower bounds, and the algorithm seeks a solution between said upper and lower bounds.

70. A method according to claim 39, wherein said estimate values are initialised to a value which is within said upper and lower bounds.

71. A method according to claim 70, wherein said estimate values are initialised to a value positioned at the midpoint of said upper and lower bounds.

72. A computer apparatus for solving a system of N linear equations in N unknown variables, the apparatus comprising:
a program memory containing processor readable instructions; and
a processor for reading and executing the instructions contained in the program memory;
wherein said processor readable instructions comprise instructions controlling the processor to carry out the method according to claim 39.

73. A data carrier carrying computer readable program code to cause a computer to execute procedure in accordance with the method of claim 39.

74. A method for solving a system of N linear equations in N unknown variables of the form:
Rh=β
the method comprising:
generating a quadratic function of the form:
$$J ( h ) = {\sum }_{m = 1}^{N} {\sum }_{n = 1}^{N} R ( m , n ) h ( m ) h ( n ) - 2 {\sum }_{n = 1}^{N} β ( n ) h ( n ) ; \text{and}$$
minimising said function using co-ordinate descent optimisation;
wherein R is a coefficient matrix of the system of linear equations; h is a vector of the N unknown variables; β is a vector containing the value of the right hand side of each equation; R(m,n) is an element of the matrix R; h(m) is the mth element of the matrix h; and β (n) is the nth element of the vector β.

75. A computer processor configured to solve a system of N linear equations in N unknown variables, comprising:
storage means for storing an estimate value for each unknown variable;
storage means for storing coefficients of each unknown variable in each equation;
storage means for storing a scalar value d;
initialising means for initialising each estimate value;
computing means configured to process each estimate value by determining whether a respective predetermined condition is satisfied, and to update the estimate if and only if the respective predetermined condition is satisfied, said computing means being configured to repeatedly process each estimate value until each estimate value is sufficiently close to an accurate value of the respective unknown variable.

76. A computer processor according to claim 75, further comprising update means for updating the scalar value d.

77. A computer processor according to claim 76, wherein said update means divides the value of the scalar value d by a value equal to a power of two.

78. A computer processor according to claim 77, wherein said update means divides the value of the scalar value d by a value equal to two.

79. A computer processor according to claim 77, wherein said update means is a bit shift device.

80. A computer processor configured to solve a system of N linear equations in N unknown variables, comprising:
storage means for storing an estimate value for each unknown variable;
storage means for storing coefficients of each unknown variable in each equation;
storage means for storing a scalar value d;
initialising means for initialising each estimate value;
computing means configured to:
(a) attempt to update each estimate value using a scalar value d,
(b) update the scalar value d if no updates are made in step (a); and
(c) repeat step (a) and step (b) until each estimate value is sufficiently close to an accurate value of the respective unknown variable.

81. A multiuser receiver device for obtaining data transmitted by a plurality of users, the device comprising:
a plurality of filters, each filter being arranged to filter out a spreading code used by a respective user;
equation solving means to find a solution h of a system of linear equations of the form Rh=β where R is the cross correlation of the spreading codes used by the plurality of users, and β is a vector containing the filter output signals; and
means to obtain the transmitted data using a solution provided by the equation solving means;
wherein the equation solving means:
(a) stores an estimate value for each value of the solution h
(b) initialises each estimate value to a predetermined value;
(c) for each estimate value:
(i) determines whether a respective predetermined condition is satisfied; and
(ii) updates the estimate if and only if the respective predetermined condition is satisfied; and
(d) repeats step (c) until each estimate value is sufficiently close to an accurate value of the respective unknown variable.

82. A multiuser receiver device for obtaining data transmitted by a plurality of users, the device comprising:
a plurality of filters, each filter being arranged to filter out a spreading code used by a respective user;
equation solving means to find a solution h of a system of linear equations of the form Rh=β where R is the cross correlation of the spreading codes used by the plurality of users, and β is a vector containing the filter output signals; and
means to obtain the transmitted data using a solution provided by the equation solving means;
wherein the equation solving means:
(a) stores an estimate value for each unknown variable;
(b) initialises each estimate value to a predetermined value;
(c) attempts to update each estimate value using a scalar value d;
(d) updates the scalar value if no updates are made in step (c); and
(e) repeats step (c) and step (d) until each estimate value is sufficiently close to an accurate value of the respective unknown variable.

83. A method for generating filter coefficients for use in an echo cancellation apparatus, the method comprising:
(a) generating a cross correlation matrix R containing the cross correlation of first and second signals and;
(b) generating an auto correlation vector β containing an autocorrelation of the first signal; and
(c) determining a vector h for which Rh=β, said vector h containing the said filter coefficients;
wherein the vector h is determined by solving the system of equations Rh=β by:
(d) storing an estimate value for each element of the vector h;
(e) initialising each estimate value to a predetermined value;
(f) for each estimate value:
(i) determining whether a respective predetermined condition is satisfied; and
(ii) updating the estimate if and only if the respective predetermined condition is satisfied; and
(g) repeating step (f) until each estimate value is sufficiently close to an accurate value of the respective unknown variable.

84. A method for generating filter coefficients for use in an echo cancellation apparatus, the method comprising:
(a) generating a cross correlation vector β containing the cross correlation of first and second signals;
(b) generating an auto correlation matrix R containing an autocorrelation of the first signal; and
(c) determining a vector h for which Rh=β, said vector h containing the said filter coefficients;
wherein the vector h is determined by solving the system of equations Rh=β by:
(d) storing an estimate value for each unknown variable;
(e) initialising each estimate value to a predetermined value;
(f) attempting to update each estimate value using a scalar value d;
(g) updating the scalar value if no updates are made in step (f); and
(h) repeating step (g) and step (h) until each estimate value is sufficiently close to an accurate value of the respective unknown variable.

85. A method for solving a system of linear equations, comprising the steps of:
a. representing elements of a solution vector as fixed point binary words each consisting of at least one bit;
b. initialising the solution vector and an auxiliary vector;
c. performing, for each bit representing the binary words, bit-wise iterations comprising the steps of:
i. performing passes through all elements of the solution vector;
ii. updating elements of the solution vector in the passes;
iii. updating elements of the auxiliary vector in the passes;
iv. repeating the passes until a finishing condition is fulfilled;
d. stopping solving the system of linear equations when a stopping condition is fulfilled.

86. The method as defined in claim 85, wherein elements of the solution vector are initialised as zeros.

87. The method as defined in claim 85, wherein the auxiliary vector is initialised by the right-side vector of the system of linear equations.

88. The method as defined in claim 85, wherein the bit-wise iterations start from the most significant bit and proceed with the next less significant bit if the finishing condition is fulfilled.

89. The method as defined in claim 85, wherein in each pass, in turn, for each element of the solution vector a condition successful/unsuccessful is checked.

90. The method as defined in claim 85, wherein the finishing condition is fulfilled if in a pass no element of the solution vector is updated.

91. The method as defined in claim 85, wherein the stopping condition is fulfilled if a predefined number of passes through all elements of the solution vector is exceeded.

92. The method as defined in claim 85, wherein the stopping condition is fulfilled if a predefined number of bit-wise iterations, defining the number of valuable bits in elements of the solution vector as well as accuracy of the solution, is exceeded.

93. The method as defined in claim 85, wherein the stopping condition is fulfilled if a computer time predefined for performing this method is finished.

94. The method as defined in claim 85, wherein when passing through elements of the solution vector the order of analysing elements of the solution vector in the pass is arbitrary.

95. The method as defined in claim 85, wherein when passing through elements of the solution vector the pass starts from an element whose position corresponds to the position of an element of the auxiliary vector with maximum amplitude and in the order of reducing the amplitude.

96. The method as defined in claim 95, wherein ordering elements of the auxiliary vector is performed to define the order of elements in the pass.

97. The method as defined in claim 89 wherein updating elements of the solution vector and the auxiliary vector is performed only if the condition successful/unsuccessful is successful.

98. The method as defined in claim 97, wherein the only element of the solution vector is updated, for which the condition successful/unsuccessful is checked.

99. The method as defined in claim 98, wherein a finite number of possible updates of the element of the solution vector are analysed for finding a preferable update and the element of the solution vector when updated is set to be equal to the preferable update.

100. The method as defined in claim 99 wherein finding the preferable update comprises the steps of:
e. calculating, for each possible update, an auxiliary value;
f. finding a minimum among the auxiliary values;
g. calculating a threshold;
h. comparing the minimum with the threshold;
i. choosing the preferable update as that corresponding to the minimum.

101. The method as defined in claim 100, wherein the condition successful/unsuccessful is successful if the minimum among the auxiliary values is less than the threshold, and the condition successful/unsuccessful is unsuccessful if the minimum among the auxiliary values is higher than or equal to the threshold.

102. The method as defined in claim 100, wherein calculating the auxiliary values is based on the corresponding element of the auxiliary vector.

103. The method as defined in claim 100, wherein calculating the threshold is performed by using a diagonal element of the coefficient matrix, the diagonal element corresponding to the element of the solution vector, and a step-size parameter.

104. The method as defined in claim 103, wherein the step-size parameter is decreased after each bit-wise iteration.

105. The method as defined in claim 104, wherein decreasing the step-size is by a factor of two.

106. The method as defined in claim 95, wherein elements of the auxiliary vector are updated by using elements of the coefficient matrix and the step-size parameter.

107. The method as defined in claim 106, wherein an element of the auxiliary vector is updated by using elements of a row of the coefficient matrix, the row corresponding to the updated element of the auxiliary vector, and the step-size parameter.

108. A computer system for solving a system of linear equations, comprising:
j. a host processor producing itself or receiving from other devices parameter signals representing elements of a coefficient matrix and right-side vector of the system of linear equations and transmitting to other devices parameter signals representing elements of a solution vector;
k. a host bus coupled to the host processor;
l. an internal bus;
m. a first means for storing and updating elements of the solution vector, the first means coupled to the host bus and the internal bus;
n. a second means for storing elements of the coefficient matrix, the second means coupled to the host and internal buses;
o. a third means for determining successful iterations and preferable updates, the third means coupled to the internal bus and the second means;
p. a fourth means for storing and updating elements of an auxiliary vector, the fourth means coupled to the host bus, the internal bus, and the second means.

109. The computer system of claim 108, comprising a controller coupled to the host bus and the internal bus, receiving control signals from the host processor through the host bus and producing control signals for the internal bus.

110. The computer system of claim 109, wherein the first means contains a memory means for storing elements of the solution vector and a means for adding or subtracting, and the first means updates elements of the solution vector by adding or subtracting a step-size parameter.

111. The computer system of claim 108, wherein the second means contains a memory means for storing elements of the coefficient matrix and a means for bit-shifting, and the second means performs bit-shifts of elements of the coefficient matrix.

112. The computer system of claims 108, wherein the fourth means contains a memory means for storing elements of the auxiliary vector and a means for adding or subtracting, and the fourth means updates elements of the auxiliary vector by adding or subtracting bit-shifted elements of the coefficient matrix.

113. The computer system of claim 108, wherein the fourth means receives initialisation data from the host bus.

114. The computer system of claim 108, wherein the fourth means receives initialisation data from the host bus, the initialisation data being elements of the right-side vector of the system of linear equations.

115. The computer system of claim 108, wherein the second means receives elements of the coefficient matrix from the host bus.

116. The computer system of claim 108, wherein the third means determines successful iterations by comparing elements of the auxiliary vector and bit-shifted elements of the coefficient matrix.

117. A multiuser receiving method in a data transmission system in which code division multiple access, involving multiuser interference among respective signals, each signal representing a succession of data signals translated into bits and transmitted at a rate of a plurality of chips per bit, spread by a respective spreading code, is applied for detecting a particular data signal, from among a plurality of data signals, said method comprising:
q. filtering matched with the spreading codes and applied to the received signal to obtain respective output signals;
r. transforming the matched-filter output signals by solving a system of linear equations of the kind Rh=β where R is a N×N cross-correlation matrix of the spreading codes, f is a N×1 vector grouping the matched-filter output signals, h is the N×1 solution vector representing the transformed signals, and N is a number of used spreading codes, wherein solving the system of linear equations comprises the steps of:
i. representing elements of a solution vector as fixed-point binary words each comprising at least one bit;
ii. initialising the solution vector and an auxiliary vector;
iii. performing, for each bit representing the binary words, bit-wise iterations comprising the steps of: performing passes through all elements of the solution vector; updating elements of the solution vector in the passes; updating elements of the auxiliary vector in the passes; repeating the passes until a finishing condition is fulfilled;
iv. stopping solving the system of linear equations when a stopping condition is fulfilled.
s. subjecting the transformed signals to obtain estimates of the data signals.

118. A multiuser receiver in a data transmission system in which code division multiple access, involving multiuser interference among respective signals, each signal representing a succession of data signals translated into bits and transmitted at a rate of a plurality of chips per bit, spread by a respective spreading code, is applied for detecting a particular data signal, from among a plurality of data signals, said multiuser receiver comprising:
t. filters matched with spreading codes contained in the received signals;
u. a computer system for solving systems of linear equations of the kind Rh=β where R is a NxN cross-correlation matrix of the spreading codes, β is a N×1 vector grouping the matched-filter output signals, h is the N×1 solution vector representing the output signals of the computer system, and N is a number of used spreading codes, wherein the computer system performs a sequence of operations comprising the steps of:
i. representing elements of a solution vector as fixed-point binary words each consisting at least one bit;
ii. initialising the solution vector and an auxiliary vector;
iii. performing, for each bit representing the binary words, bit-wise iterations comprising the steps of: performing passes through all elements of the solution vector; updating elements of the solution vector in the passes; updating elements of the auxiliary vector in the passes; repeating the passes until a finishing condition is fulfilled;
iv. stopping solving the system of linear equations when a stopping condition is fulfilled.
v. a means for estimating the data signals from the output signals of the computer system.

119. A multiuser receiver according to claim 34, wherein the computer system for solving the system of linear equations comprises;
w. a host processor receiving parameter signals representing elements of the cross-correlation matrix of the spreading codes and right-side vector of the system of linear equations and transmitting parameter signals representing elements of the solution vector;
x. a host bus coupled to the host processor;
y. an internal bus;
z. a first means for storing and updating elements of the solution vector, the first means coupled to the host bus and the internal bus;
aa. a second means for storing elements of the cross-correlation matrix, the second means coupled to the host bus and the internal bus;
bb. a third means for determining successful iterations and preferable updates, the third means coupled to the internal bus and the second means;
cc. a fourth means for updating and storing elements of an auxiliary vector, the fourth means coupled to the host bus, the internal bus, and the second means.

120. An adaptive filter for receiving a first signal from a first transmission line and a second signal from a second transmission line, said first signal partially leaking from said first transmission line to said second transmission line as an echo, said adaptive filter comprising a filter means coupled to said first transmission line and responsive to said first signal for producing an estimated echo signal determined in accordance with filter coefficients, a coefficient generating means for generating said filter coefficients and subtracting means coupled to said filter means and connected in said second transmission line for subtracting said estimated echo signal from said second signal on said second transmission line so as to cancel said echo signal, said coefficient generating means comprises:
dd. a first means coupled to said first transmission line and responsive to said first signal for producing a series of autocorrelation coefficients of said first signal;
ee. a second means coupled to said first and said second transmission lines and responsive to said first and said second signal for producing a series of cross-correlation coefficients between said first signal and said second signal; and
ff. a means coupled to said first and said second means for generating said filter coefficients from said autocorrelation and cross-correlation coefficients to deliver said filter coefficients to said filter means, said third means is a computer system for solving a system of linear equations whose coefficient matrix comprises said autocorrelation coefficients and whose right-side vector comprises said cross-correlation coefficients, wherein said computer system for solving the system of linear equations performs a sequence of operations comprising the steps of:
i. representing elements of a solution vector as fixed-point binary words each consisting of at least one bit;
ii. initialising the solution vector and an auxiliary vector;
iii. performing, for each bit representing the binary words, bit-wise iterations comprising the steps of: performing passes through all elements of the solution vector updating elements of the solution vector in the passes; updating elements of the auxiliary vector in the passes; repeating the passes until a finishing condition is fulfilled;
iv. stopping solving the system of linear equations when a stopping condition is fulfilled.

121. The adaptive filter of claim 120, wherein the computer system for solving the system of linear equations comprises:
gg. a host processor receiving parameter signals representing elements of the coefficient matrix and the right-side vector and transmitting parameter signals representing elements of the solution vector;
hh. a host bus coupled to the host processor;
ii. an internal bus;
jj. a first means for storing and updating elements of the solution vector, the first means coupled to the host bus and the internal bus;
kk. a second means for storing elements of the coefficient matrix, the second means coupled to the host bus and the internal bus;
ll. a third means for determining successful iterations and preferable updates, the third means coupled to the internal bus and the second means;
mm. a fourth means for storing and updating elements of an auxiliary vector, the fourth means coupled to the host bus, internal bus, and the second means.

122. The adaptive filter of claim 121, wherein said filter means is a transversal filter.
